(19) United States
(12) Patent Application Publication
(10) Pub. No.: US 2017/0170467 A1
(43) Pub. Date: Jun. 15, 2017

(54) ALL-SOLID-STATE BATTERY AND METHOD FOR PRODUCING ALL-SOLID-STATE BATTERY

(71) Applicant: TOYOTA JIDOSHA KABUSHIKI KAISHA, Toyota-shi (JP)

(72) Inventor: Hidenori MIKI, Hiratsuka-shi (JP)

(73) Assignee: TOYOTA JIDOSHA KABUSHIKI KAISHA, Toyota-shi (JP)

(21) Appl. No.: 15/375,484

(22) Filed: Dec. 12, 2016

(30) Foreign Application Priority Data
Dec. 15, 2015 (JP) 2015-244640

(51) Int. Cl. H01M 4/36; H01M 10/0525; H01M 4/58; H01M 10/0585

(52) U.S. Cl. CPC H01M 4/366; H01M 10/0585; H01M 10/0525; H01M 4/5825; H01M 2004/028

(57) ABSTRACT

The positive electrode active material layer has a first positive electrode active material represented by LiₓY_{y}PO_{z} wherein, Y represents at least one element selected from the group consisting of Ni, Mn and Co, and a second positive electrode active material represented by Li_{x′}Fe_{y′}PO_{z′}. The second positive electrode active material is (1) arranged as the sulfide solid electrolyte layer side part of the positive electrode active material layer (2) arranged on the surface of particles of the first positive electrode active material, or (3) arranged as the sulfide solid electrolyte layer side part of the positive electrode active material layer and arranged on the surface of particles of the first positive electrode active material.

### CROSS-REFERENCE TO RELATED APPLICATION

This application claims priority to Japanese Patent Application No. 2015-244640 filed on Dec. 15, 2015, the entire contents of which are hereby incorporated by reference into the present application.

### TECHNICAL FIELD

The present disclosure relates to a sulfide all-solid-state battery having an olivine-type positive electrode active material and a method for producing the same.

### BACKGROUND ART

Among the various types of batteries available at present, lithium ion batteries are attracting attention from the viewpoint of their high energy density. Among these batteries, all-solid-state batteries, in which the electrolytic solution has been replaced with a solid electrolyte, are attracting particular attention. This is because, differing from secondary batteries using an electrolytic solution, since all-solid-state batteries do not use an electrolytic solution, there is no degradation of the electrolytic solution caused by overcharging and these batteries have high cycling characteristics and high energy density.

Olivine-type positive electrode active materials are known to be used for the positive electrode active materials used in lithium ion batteries. Olivine-type positive electrode active materials have a more stable structure and higher cycling characteristics in comparison with other positive electrode active materials. Consequently, research has recently been conducted on all-solid-state batteries using olivine-type positive electrode active materials.

Patent Document 1 discloses that an olivine-type positive electrode active material in the form of LiXPO₄ wherein, X represents Fe, Co, Ni or Mn, can be used for the positive electrode active material of an all-solid-state battery.

In addition, Patent Document 2 discloses an all-solid-state battery that uses amorphous lithium iron phosphate for the positive electrode active material as an example of an all-solid-state battery that uses a positive electrode active material that functions as a positive electrode active material in an amorphous state and has high ion conductivity.

### PRIOR ART DOCUMENTS

### Patent Documents

[Patent Document 1] Unexamined Patent Application Publication (Translation of PCT Application) No. 2014-534591

[Patent Document 2] Japanese Unexamined Patent Publication No. 2011-108533

### SUMMARY

### Problems to be Solved

Although an olivine-type positive electrode active material is said to be able to be used as a positive electrode active material of an all-solid-state battery as in Patent Document 1, only all-solid-state batteries using lithium iron phosphate and a sulfide solid electrolyte have actually been produced as indicated in Patent Document 2. In other words, there have been no reported examples of the production of an all-solid-state battery that uses a sulfide solid electrolyte and an olivine-type positive electrode active material other than lithium iron phosphate.

In actuality, all-solid-state batteries using a sulfide solid electrolyte and an olivine-type positive electrode active material other than lithium iron phosphate demonstrate a remarkable decrease in battery capacity. This is thought to be because, when such an all-solid-state battery has been charged, a chemical reaction occurs between the olivine-type positive electrode active material and the sulfide solid electrolyte that results in the formation of a resistive layer at the interface between the olivine-type positive electrode active material and sulfide solid electrolyte.

An object of the present disclosure is to provide an all-solid-state battery that has a sulfide solid electrolyte and an olivine-type positive electrode active material other than LiFePO₄ and demonstrates improved battery capacity, and a method for producing the same.

### Means for Solving the Problems

Means for solving the problems of the present disclosure are as indicated below.

1. An all-solid-state battery having a positive electrode active material layer, a sulfide solid electrolyte layer and a negative electrode active material layer in that order; wherein,

the positive electrode active material layer has a first positive electrode active material represented by LiₓY_{y}PO_{z}, wherein, Y represents at least one element selected from the group consisting of Ni, Mn and Co, x is such that 0.5≦x≦1.5, y is such that 0.5≦y≦1.5 and z is such that 2≦z≦7 and a second positive electrode active material represented by Li_{x′}Fe_{y′}PO_{z′}, wherein, x′ is such that 0.5≦x′≦1.5, y′ is such that 0.5≦y′≦1.5 and z′ is such that 2≦z′≦7, and

the second positive electrode active material is (1) arranged as the sulfide solid electrolyte layer side part of the positive electrode active material layer, (2) arranged on the surface of particles of the first positive electrode active material, or (3) arranged as the sulfide solid electrolyte layer side part of the positive electrode active material layer and arranged on the surface of particles of the first positive electrode active material.

2. A method for producing an all-solid-state battery having a positive electrode active material layer, a solid electrolyte layer and a negative electrode active material layer in that order; comprising:

producing an all-solid-state battery precursor having the positive electrode active material layer, the solid electrolyte layer and the negative electrode active material layer in that order, and carrying out charge-discharge cycles in which the all-solid-state battery precursor is discharged to 2.1 V vs. Li/Li⁺ or lower while maintaining the temperature of the all-solid-state battery precursor at 25° C. to 80° C.; wherein,

the positive electrode active material layer has a first positive electrode active material represented by LiₓY_{y}PO_{z}, wherein, Y represents at least one element selected from the group consisting of Ni, Mn and Co, x is such that 0.5≦x≦1.5, y is such that 0.5≦y≦1.5 and z is such that 2≦z≦7, and a second positive electrode active material represented by Li_{x′}Fe_{y′}PO_{z′}, wherein, x′ is such that 0.5≦x′≦1.5, y′ is such that 0.5≦y′≦1.5 and z′ is such that 2≦z′≦7, and

the second positive electrode active material is (1) arranged as the sulfide solid electrolyte layer side part of the positive electrode active material layer, (2) arranged on the surface of particles of the first positive electrode active material, or (3) arranged as the sulfide solid electrolyte layer side part of the positive electrode active material layer and arranged on the surface of particles of the first positive electrode active material.

3. The method for producing an all-solid-state battery described in 2 above, wherein during the charge-discharge cycles, the all-solid-state battery precursor is discharged until the electrical potential of the positive electrode active material layer reaches 1.6 V vs. Li/Li⁺ to 2.1 V vs. Li/Li⁺.

4. The production method described in 2 or 3 above, wherein the charge-discharge cycles are carried out at a charge-discharge rate of 1.0 C or less.

5. The production method described in any of 2 to 4 above, wherein during the charge-discharge cycles, the battery precursor is charged until the electrical potential of the positive electrode active material layer reaches 3.8 V vs. Li/Li⁺ to 4.4 V vs. Li/Li⁺.

6. The production method described in any of 2 to 5 above, wherein the charge-discharge cycles are repeated until the discharge capacity of the all-solid-state battery precursor becomes greater than the discharge capacity of the initial charge-discharge cycle of the battery precursor.

7. The production method described in any of 2 to 6 above, wherein the charge-discharge cycles are carried out until a discharge plateau is no longer observed at 2.1 V vs. Li/Li⁺ to 2.5 V vs. Li/Li⁺ for the positive electrode active material layer during discharge.

8. The production method described in any of 2 to 7 above, wherein the charge-discharge cycles are carried out until a discharge plateau appears at 3.3 V vs. Li/Li⁺ to 3.5 V vs. Li/Li⁺ for the positive electrode active material layer during discharge.

9. The production method described in any of 2 to 8 above, wherein the plurality of charge-discharge cycles are carried out continuously.

10. The production method described in 9 above, wherein the charge-discharge cycles are carried out from the initial charging and discharge.

11. The production method described in any of 2 to 10 above, further comprising carrying out the charge-discharge cycles for at least three cycles, followed by warming the all-solid-state battery precursor to 40° C. to 80° C. for 40 hours or more.

### Effects

According to the present disclosure, an all-solid-state battery having a sulfide solid electrolyte and an olivine-type positive electrode active material other than LiFePO₄ and demonstrating improved battery capacity, and a method for producing the same, can be provided.

### BRIEF DESCRIPTION OF THE DRAWINGS

FIG. 1 is a schematic cross-sectional view of one embodiment of the all-solid-state battery of the present disclosure.

FIG. 2 is a schematic cross-sectional view of a positive electrode active material particle in one embodiment of the all-solid-state battery of the present disclosure.

FIG. 3 is a schematic cross-sectional view of an all-solid-state battery having an olivine-type positive electrode active material other than LiFePO₄ in the positive electrode active material layer.

FIG. 4 is a schematic cross-sectional view of an all-solid-state battery uniformly having LiFePO₄ and an olivine-type positive electrode active material other than LiFePO₄ in the positive electrode active material layer.

FIG. 5 is a schematic cross-sectional view of an olivine-type positive electrode active material particle in which a resistive layer on the surface thereof has been formed.

FIG. 6 is a schematic cross-sectional view of an olivine-type positive electrode active material particle in which a resistive layer on the surface thereof has been destroyed.

FIG. 7A is a graph indicating the results of cyclic voltammetry for the all-solid-state battery of the present disclosure.

FIG. 7B is a graph indicating the results of cyclic voltammetry for the all-solid-state battery of the present disclosure.

FIG. 8 is a graph indicating the results of cyclic voltammetry for an all-solid-state battery uniformly having LiCoPO₄ and LiFePO₄ in the positive electrode active material layer.

FIG. 9 is a graph indicating the results of cyclic voltammetry for an all-solid-state battery having LiCoPO₄ for the positive electrode active material.

FIG. 10A is a graph representing the relationship between voltage and battery capacity of an all-solid-state battery which has been repeatedly charged-discharged while maintaining the temperature at 25° C.

FIG. 10B is a graph representing the relationship between voltage and battery capacity of an all-solid-state battery which has been repeatedly charged-discharged while maintaining the temperature at 42° C.

FIG. 10C is a graph representing the relationship between voltage and battery capacity of an all-solid-state battery which has been repeatedly charged-discharged while maintaining the temperature at 60° C.

FIG. 10D is a graph representing the relationship between voltage and battery capacity of an all-solid-state battery which has been repeatedly charged-discharged while maintaining the temperature at 80° C.

FIG. 10E is a graph representing the relationship between voltage and battery capacity of an all-solid-state battery which has been repeatedly charged-discharged while maintaining the temperature at 100° C.

FIG. 11A is a graph representing the relationship between voltage and battery capacity of an all-solid state battery which has been repeatedly charged-discharged while maintaining the charge-discharge rate at 0.02 C.

FIG. 11B is a graph representing the relationship between voltage and battery capacity of an all-solid state battery which has been repeatedly charged-discharged while maintaining the charge-discharge rate at 0.05 C.

FIG. 11C is a graph representing the relationship between voltage and battery capacity of an all-solid state battery which has been repeatedly charged-discharged while maintaining the charge-discharge rate at 0.1 C.

FIG. 11D is a graph representing the relationship between voltage and battery capacity of an all-solid state battery which has been repeatedly charged-discharged while maintaining the charge-discharge rate at 0.5 C.

FIG. 11E is a graph representing the relationship between voltage and battery capacity of an all-solid state battery which has been repeatedly charged-discharged while maintaining the charge-discharge rate at 1.0 C.

FIG. 12A is a graph representing the relationship between voltage and battery capacity of an all-solid state battery which has been repeatedly charged-discharged while maintaining the upper limit charging potential of a positive electrode active material layer at 3.8 V vs. Li/Li⁺.

FIG. 12B is a graph representing the relationship between voltage and battery capacity of an all-solid state battery which has been repeatedly charged-discharged while maintaining the upper limit charging potential of a positive electrode active material layer at 4.1 V vs. Li/Li⁺.

FIG. 12C is a graph representing the relationship between voltage and battery capacity of an all-solid state battery which has been repeatedly charged-discharged while maintaining the upper limit charging potential of a positive electrode active material layer at 4.4 V vs. Li/Li⁺.

FIG. 12D is a graph representing the relationship between voltage and battery capacity of an all-solid state battery which has been repeatedly charged-discharged while maintaining the upper limit charging potential of a positive electrode active material layer at 4.7 V vs. Li/Li⁺.

FIG. 13A is a graph representing the relationship between voltage and battery capacity of an all-solid state battery which has been repeatedly charged-discharged while maintaining the lower limit discharge potential of a positive electrode active material layer at 1.6 V vs. Li/Li⁺.

FIG. 13B is a graph representing the relationship between voltage and battery capacity of an all-solid state battery which has been repeatedly charged-discharged while maintaining the lower limit discharge potential of a positive electrode active material layer at 2.1 V vs. Li/Li⁺.

FIG. 13C is a graph representing the relationship between voltage and battery capacity of an all-solid state battery which has been repeatedly charged-discharged while maintaining the lower limit discharge potential of a positive electrode active material layer at 2.3 V vs. Li/Li⁺.

FIG. 14 is a graph representing the relationship between voltage and battery capacity of an all-solid state battery which has been stored for 40 hours at 80° C. following charge-discharge cycles.

### DETAILED DESCRIPTION

<<All-Solid-State Battery of the Present Disclosure>>

The following provides a detailed description of embodiments of the present disclosure. Furthermore, the present disclosure is not limited to the following embodiments, but rather can be modified in various ways within the scope of the gist thereof.

The all-solid-state battery of the present disclosure has a positive electrode active material layer, a sulfide solid electrolyte layer and a negative electrode active material layer in that order. The positive electrode active material layer has a first positive electrode active material represented by LiₓY_{y}PO_{z}, wherein, Y represents at least one element selected from the group consisting of Ni, Mn and Co, x is such that 0.5≦x≦1.5, y is such that 0.5≦y≦1.5 and z is such that 2≦z≦7 and a second positive electrode active material represented by Li_{x′}Fe_{y′}PO_{z′}, wherein, x′ is such that 0.5≦x′≦1.5, y′ is such that 0.5≦y′≦1.5 and z′ is such that 2≦z′≦7. In addition, the second positive electrode active material is (1) arranged as the sulfide solid electrolyte layer side part of the positive electrode active material layer (2) arranged on the surface of particles of the first positive electrode active material, or (3) arranged as the sulfide solid electrolyte layer side part of the positive electrode active material layer and arranged on the surface of particles of the first positive electrode active material.

The operating principle of the present disclosure is thought to be as indicated below, although the present disclosure is not limited by that principle.

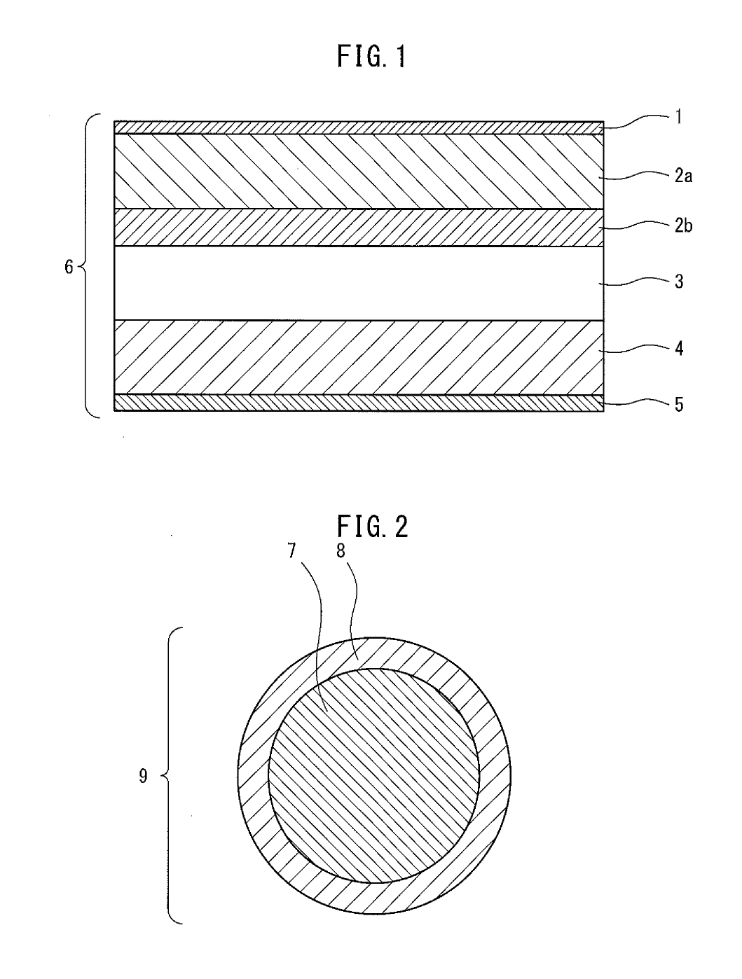

FIG. 1 is a schematic cross-sectional view of one embodiment of the all-solid-state battery of the present disclosure. The all-solid-state battery 6 of the present disclosure has a positive electrode current collector 1, positive electrode active material layers 2a, 2b, a sulfide solid electrolyte layer 3, a negative electrode active material layer 4 and a negative electrode current collector 5. In FIG. 1, the all-solid-state battery has a first positive electrode active material layer 2a having a first positive electrode active material, and a second positive electrode active material layer 2b having a second positive electrode active material. Incidentally, FIG. 1 merely indicates one embodiment of the present disclosure, and is not intended to limit the content of the present disclosure.

In addition, FIG. 2 is a schematic cross-sectional view of a positive electrode active material particle in another embodiment of the all-solid-state battery of the present disclosure. In this drawing, a positive electrode active material particle 9 has a first positive electrode active material 7, and the first positive electrode active material 7 is coated by a second positive electrode active material 8. Incidentally, FIG. 2 merely indicates one embodiment of the present disclosure, and is not intended to limit the content of the present disclosure.

The inventors of the present disclosure found that, when an all-solid state battery that uses lithium iron phosphate for the positive electrode active material and uses sulfide solid electrolyte for the solid electrolyte is charged, simultaneous to the formation of a resistive layer between the lithium iron phosphate and sulfide solid electrolyte, the constituent element of the lithium iron phosphate is eliminated therefrom on the inside of this resistive layer, namely at the interface between this resistive layer and the lithium iron phosphate, resulting in the formation of a coating layer. This coating layer is a stable phosphate layer that contains little iron and exhibits little reactivity with the sulfide solid electrolyte. Therefore, this coating layer has the function of a protective layer that inhibits the lithium iron phosphate from reacting with the sulfide solid electrolyte during charging and discharging of the battery.

In addition, the inventors of the present disclosure found that, since this resistive layer formed at the interface between lithium iron phosphate and sulfide solid electrolyte can be removed by repeatedly subjecting the all-solid-state battery to charge-discharge cycles under certain conditions, olivine-type positive electrode active materials other than lithium iron phosphate such as LiNiPO₄, LiMnPO₄ or LiCoPO₄ can also be used efficiently by using a positive electrode active material having lithium iron phosphate on the surface of positive electrode active material particles and/or arranging a positive electrode active material having lithium iron phosphate as the sulfide solid electrolyte layer side part of the positive electrode active material layer. Conditions subsequently described in the section entitled <<Method for Producing All-Solid-State Battery of the Present Disclosure>> are particularly preferable for the charge-discharge cycles conditions used to remove the resistive layer.

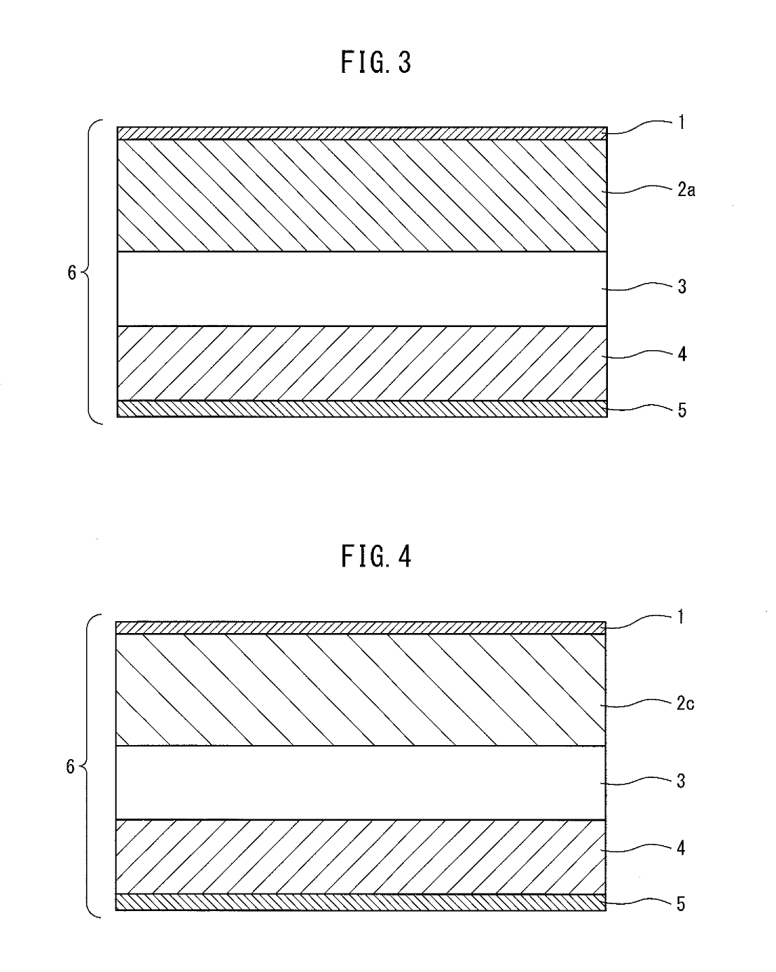

FIG. 3 is a schematic cross-sectional view of an all-solid-state battery that uses an olivine-type positive electrode active material other than lithium iron phosphate such as LiNiPO₄, LiMnPO₄ or LiCoPO₄. In this drawing, the all-solid-state battery 6 has the positive electrode current collector 1, the positive electrode active material layer 2a having the first positive electrode active material, the sulfide solid electrolyte layer 3, the negative electrode active material layer 4 and the negative electrode current collector 5. Here, the first positive electrode active material contains LiNiPO₄, LiMnPO₄ or LiCoPO₄ and the like.

This type of all-solid-state battery does not demonstrate an improvement in battery capacity even if subjected to repeated charge-discharge cycles under certain conditions. Although the reason for this is not clear, it is thought to be because the resistive layer is unable to be removed by charging and discharging and/or because a protective layer is unable to be formed.

In contrast, in the all-solid-state battery of the present disclosure, the second positive electrode active material layer 2b is present between the first positive electrode active material layer 2a and the sulfide solid electrolyte layer 3, the second positive electrode active material layer having the second positive electrode active material containing lithium iron phosphate, and, the first positive electrode active material layer having the first positive electrode active material. Although a resistive layer is also formed between the second positive electrode active material layer 2b and the sulfide solid electrolyte layer 3 when the all-solid-state battery of the present disclosure has been charged as well, since this resistive layer is easily removed when the all-solid-state battery is subjected to repeated charge-discharge cycles under certain conditions such as the conditions subsequent described in the section entitled <<Method for Producing All-Solid-State Battery of the Present Disclosure>>, adequate battery capacity can be obtained.

In other words, as a result of having the second positive electrode active material sandwiched between the first positive electrode active material and the sulfide solid electrolyte, the first positive electrode active material can be used efficiently without reacting with the sulfide solid electrolyte layer.

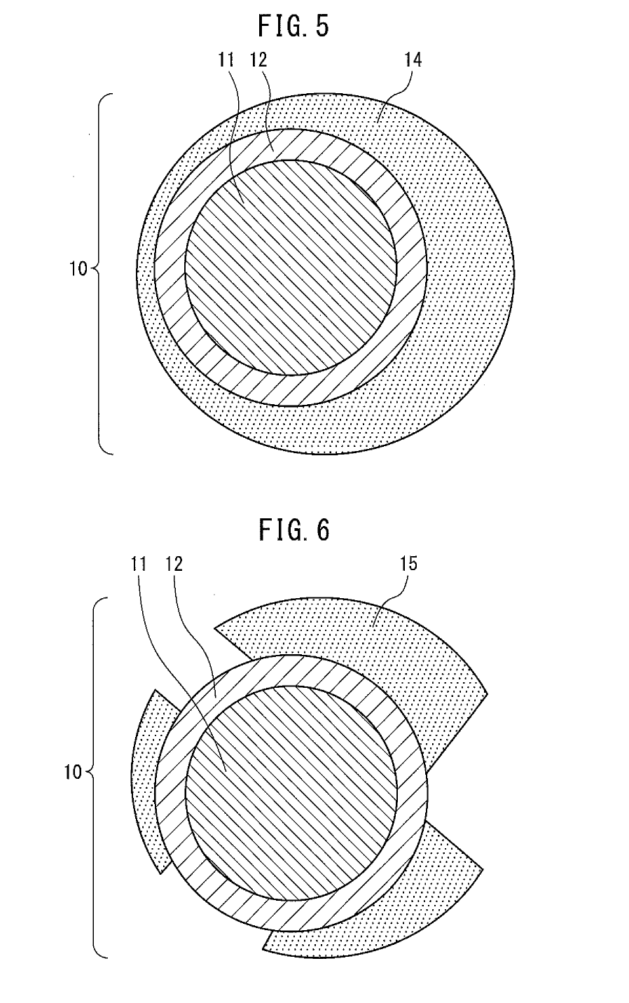

Incidentally, even if a positive electrode active material is used that contains a first positive electrode active material and a second positive electrode active material in the same manner as the present description, if the all-solid-state battery has a positive electrode active material layer 2c obtained by uniformly mixing the first positive electrode active material and the second positive electrode active material in the manner of FIG. 4, since a resistive layer is formed at the interface between the positive electrode active material layer and sulfide solid electrolyte layer due to a reaction between the first positive electrode active material and the sulfide solid electrolyte, the capacity of the all-solid-state battery is low despite repeating charge-discharge cycles under certain conditions.

<All-Solid-State Battery>

The all-solid-state battery of the present disclosure has a positive electrode active material layer, a sulfide solid electrolyte layer and a negative electrode active material layer in that order.

1. Positive Electrode Active Material Layer

In the present disclosure, the positive electrode active material layer has a positive electrode active material and optionally a solid electrolyte, a conductive assistant and a binder.

(1) Positive Electrode Active Material

The all-solid-state battery of the present disclosure has a first positive electrode active material represented by LiₓM_{y}PO_{z}, wherein M represents Ni, Mn or Co, x is such that 0.5≦x≦1.5, y is such that 0.5≦y≦1.5 and z is such that 2≦z≦7, and a second positive electrode active material represented by Li_{x′}Fe_{y′}PO_{z′}, wherein x′ is such that 0.5≦x′≦1.5, y′ is such that 0.5≦y′≦1.5 and z′ is such that 2≦z′≦7.

In addition, the first positive electrode active material and the second positive electrode active material satisfy the conditions of the following (1) (2), or (3):

(1) the second positive electrode active material is arranged as the sulfide solid electrolyte layer side part of the positive electrode active material layer;

(1) the second positive electrode active material is arranged on the surface of particles of the first positive electrode active material.

(c) the second positive electrode active material is arranged as the sulfide solid electrolyte layer side part of the positive electrode active material layer and arranged on the surface of particles of the first positive electrode active material.

Furthermore, in the case of (a), a structure may be employed in which the positive electrode active material layer having the first positive electrode active material and the positive electrode active material layer having the second positive electrode active material are laminated. In addition, the second positive electrode active material may also be made to be present as the solid electrolyte layer side part of the positive electrode active material layer by a concentration gradient. Moreover, the first positive electrode active material is preferably not present as the sulfide solid electrolyte layer side part of the positive electrode active material layer. This is because the formation of a resistive layer at the interface between the positive electrode active material layer and sulfide solid electrolyte layer due to a reaction between the first positive electrode active material and the sulfide solid electrolyte is inhibited.

In addition, in the case of (b), the positive electrode active material layer may have a sulfide solid electrolyte layer. In this case, the entire first positive electrode active material is preferably continuously coated with the second positive electrode active material. This is because the formation of a resistive layer at the interface between the positive electrode active material layer and sulfide solid electrolyte layer as a result of the first positive electrode active material reacting with the sulfide solid electrolyte is inhibited.

(2) Solid Electrolyte

In the present disclosure, the positive electrode active material layer may have a solid electrolyte. There are no particular limitations on the solid electrolyte provided it is a solid electrolyte that is used as a solid electrolyte of an all-solid-state battery. Examples thereof include oxide amorphous solid electrolytes such as Li₂O—B₂O₃—P₂O₅ or Li₂O—SiO₂, sulfide solid electrolytes such as Li₂S—SiS₂, LiX—Li₂S—SiS₂, LiX—Li₂S—P₂S₅, LiX—Li₂S—P₂O₅, LiX—Li₂S—Li₂O—P₂S₅ or Li₂S—P₂S₅, and crystalline oxides/nitrides such as LiI, Li₃N, Li₅La₃Ta₂O₁₂, Li₇La₃Zr₂O₁₂, Li₆BaLa₂Ta₂O₁₂, Li₃PO_{(4-3/2w)}N_{w(w<1)} or Li_{3.6}Si_{0.6}P_{0.4}O₄. Incidentally, “X” refers to a halogen, in particular I and/or Br.

However, if a sulfide solid electrolyte is used in the positive electrode active material layer, the positive electrode active material preferably satisfies the aforementioned (b).

(3) Conductive Assistant

Examples of conductive assistants include carbon materials such as vapor-grown carbon fibers (VGCF), acetylene black, Ketjen black, carbon nanotubes (CNT) or carbon nanofibers (CNF), metals such as nickel, aluminum or stainless steel, and combinations thereof.

(4) Binder

Examples of binders include, but are not limited to, polymer resins such as polyvinylidene fluoride (PVDF), polytetrafluoroethylene (PTFE), polyimide (PI), polyamide (PA), polyamide-imide (PAI), butadiene rubber (BR), styrene butadiene rubber (SBR), nitrile butadiene rubber (NBR) or styrene-ethylene-butylene-styrene block copolymer (SEBS), carboxymethyl cellulose (CMC) and combinations thereof.

2. Sulfide Solid Electrolyte Layer

The sulfide solid electrolyte layer has a sulfide solid electrolyte and optionally has a binder. A sulfide solid electrolyte used as the solid electrolyte of an all-solid-state battery can be used for the sulfide solid electrolyte. Examples thereof include Li₂S—SiS₂, LiX—Li₂S—SiS₂, LiX—Li₂S—P₂S₅, LiX—Li₂S—P₂O₅, LiX—Li₂S—Li₂O—P₂S₅ and Li₂S—P₂S₅. Incidentally, “X” refers to a halogen, in particular I and/or Br.

In addition, the same binders described with respect to the positive electrode active material layer can be used for the binder.

3. Negative Electrode Active Material Layer

The negative electrode active material layer has a negative electrode active material and optionally has a solid electrolyte, conductive assistant and binder.

There are no particular limitations on the negative electrode active material used in the negative electrode active material layer provided it is able to occlude and release lithium ions. Specific examples of negative electrode active materials include metals such as Li, Sn, Si or In, alloys of Li and Ti, Mg or Al, carbon materials such as hard carbon, soft carbon or graphite, and combinations thereof. In particular, lithium titanate (LTO) and lithium-containing alloys are preferable from the viewpoints of cycling characteristics and discharge characteristics.

The same solid electrolytes, conductive assistants and binders described with respect to the positive electrode active material layer can be used for the solid electrolyte, conductive assistant and binder.

<<Method for Producing all-Solid-State Battery of the Present Disclosure>>

The production method of the present disclosure for producing an all-solid-state battery is a method for producing an all-solid-state battery having a positive electrode active material layer, solid electrolyte layer and negative electrode active material layer in that order that comprises producing an all-solid-state battery precursor having the positive electrode active material layer, the solid electrolyte layer and the negative electrode active material layer in that order, and carrying out charge-discharge cycles in which the all-solid-state battery precursor is discharged to 2.1 V vs. Li/Li⁺ or lower while maintaining the temperature of the all-solid-state battery precursor at 25° C. to 80° C. In addition, the positive electrode active material layer has a first positive electrode active material represented by LiₓY_{y}PO_{z}, wherein, Y represents at least one element selected from the group consisting of Ni, Mn and Co, x is such that 0.5≦x≦1.5, y is such that 0.5≦y≦1.5 and z is such that 2≦z≦7 and a second positive electrode active material represented by Li_{x′}Fe_{y′}PO_{z′}, wherein, x′ is such that 0.5≦x′≦1.5, y′ is such that 0.5≦y′≦1.5 and z′ is such that 2≦z′≦7, and the second positive electrode active material is (1) arranged as the sulfide solid electrolyte layer side part of the positive electrode active material layer (2) arranged on the surface of particles of the first positive electrode active material, or (3) arranged as the sulfide solid electrolyte layer side part of the positive electrode active material layer and arranged on the surface of particles of the first positive electrode active material.

Although not limited thereto, the operating principle of the present disclosure is thought to be as indicated below.

If lithium iron phosphate is used as an olivine-type positive electrode active material, simultaneous to the formation of a resistive layer, a constituent element of the lithium iron phosphate in the form of Fe is eliminated therefrom on the inside of this resistive layer, namely at the interface between this resistive layer and the olivine-type positive electrode active material, resulting in the formation of a coating layer. This coating layer is a stable phosphate layer that contains little Fe and exhibits little reactivity with the sulfide solid electrolyte. Consequently, this coating layer has the function of a protective layer that inhibits the lithium iron phosphate from reacting with the sulfide solid electrolyte during charging and discharging of the battery.

In addition, the inventors of the present disclosure found that, when lithium iron phosphate has been used as an olivine-type positive electrode active material, the resistive layer can be easily removed by repeating plurality of charge-discharge cycles under certain conditions. In addition, the inventors of the present disclosure also found that, in the case of containing an olivine-type positive electrode active material other than lithium iron phosphate as well, a sulfide all-solid-state battery having high capacity can be obtained by sandwiching lithium iron phosphate between the sulfide solid electrolyte layer and that olivine-type positive electrode active material.

The mechanism by which this resistive layer is removed is thought to be as indicated below. First, as shown in FIG. 5, when an all-solid-state battery using lithium iron phosphate for the positive electrode active material and a sulfide solid electrolyte is charged, a resistive layer 14 is formed at the interface between the sulfide solid electrolyte and the lithium iron phosphate 11 of a primary particle 10 of the positive electrode active material. In addition, a coating layer 12 is simultaneously formed between the resistive layer 14 and the lithium iron phosphate 11. In the case of using LiFePO₄ and Li₂PS₄, this reaction is thought to proceed in the manner of the reaction formula indicated below (and the reaction is thought to proceed in the same manner for lithium iron phosphate other than LiFePO₄).

FePO₄+Li₃PS₄→FeS₂ (resistive layer)+Li₄P₂O₇ (coating layer)+Li+e⁻

According to this reaction, a resistive layer having FeS₂ and a coating layer having Li₄P₂O₇ are thought to be formed. In addition, this reaction occurs during charging in the first cycle or first several cycles of charge-discharge cycles.

Subsequently, a reaction occurs between the FeSₓ that composes this resistive layer and lithium ions during the early discharge cycles. This reaction is thought to consist of two types of reactions. The first reaction is a reaction in which lithium ions are inserted into FeSₓ resulting in the formation of LiₓFeSₓ. This reaction occurs in the vicinity of about 2.5 V vs. Li/Li⁺. The other reaction is a reaction (conversion reaction) in which Fe present in the FeSₓ is replaced with lithium resulting in the formation of Li₂S. This reaction occurs in the vicinity of about 2.1 V vs. Li/Li⁺. These reactions are thought to proceed in the manner of the reaction formulas indicated below.

FeSₓ+xLi⁺+xe⁻→LiₓFeSₓ

FeSₓ+2xLi⁺+2xe⁻→Li₂S+Fe

When charge-discharge cycles are subsequently further repeated, the conversion reaction by which Fe in the FeSₓ is replaced with lithium during discharge continues to proceed. In addition, Fe alone or compounds thereof formed by this reaction during charging become ionized, and as a result of the diffusion of these ions, the resistive layer composed of FeSₓ is destroyed. These reactions are thought to proceed in the manner of the reaction formulas indicated below.

Fe→Fe^{x+}+xe⁻ (during charging)

FeSₓ+2xLi⁺+2xe⁻→Li₂S+Fe (during discharge)

As a result, as shown in FIG. 6, the resistive layer present at the interface between lithium iron phosphate and sulfide solid electrolyte is removed resulting in an intermittent resistive layer. At the same time, the Li₂S formed during discharge diffuses into secondary particles of the positive electrode active material, and this is thought to result in the formation of lithium ion conduction paths within the secondary particles. In addition, the resistive layer is not newly formed at those portions where the resistive layer has been destroyed since there is no reaction between the lithium iron phosphate and sulfide solid electrolyte during charging due to the presence of the coating layer 12. Accordingly, lithium iron phosphate contained in the positive electrode active material layer and olivine-type positive electrode active materials other than lithium iron phosphate are able to efficiently function as a positive electrode active material.

As a result of discharging to an electrical potential lower than the electrical potential of about 2.1 V vs. Li/Li⁺ at which this reaction occurs in lithium iron phosphate, the conversion reaction by which iron in the FeSₓ is replaced with lithium is able to proceed efficiently. Consequently, by carrying out charge-discharge cycles in which discharging proceeds until the electrical potential of the positive electrode active material layer reaches about 2.1 V vs. Li/Li⁺ or less, the resistive layer can be removed and a sulfide solid-state battery can be fabricated that has high capacity and demonstrates high cycling characteristics.

In addition, by repeating charge-discharge cycles while controlling not only the lower limit of the electrical potential of the positive electrode active material layer during discharge (herein after referred to as the “lower limit discharge potential”), but also the upper limit of the electrical potential of the positive electrode active material layer during charging (herein after referred to as the “upper limit charging potential”), the charge-discharge rate and/or the temperature of the battery to certain conditions, a sulfide solid-state battery can be fabricated more efficiently that has higher battery capacity.

During charging of the battery, the reaction by which the resistive layer is formed occurs more frequently the higher the electrical potential. If the resistive layer becomes large, it cannot be removed unless subsequent charge-discharge cycles are repeated numerous times. In addition, at a high upper limit charging potential, other side reactions occur causing the internal resistance of the all-solid-state battery to become large following completion thereof. Thus, it is preferable to suppress these side reactions by maintaining the upper limit charging potential to a certain potential or lower.

In addition, when the charge-discharge rate has been lowered, duration which an electrical potential is at the electrical potential at which the conversion reaction by Fe in the FeSₓ is replaced with lithium occurs becomes longer. As a result, the number of reactions that occur due to a single charge-discharge cycle can be increased. Consequently, the number of charge-discharge cycles required to remove the resistive layer can be reduced by lowering the charge-discharge rate.

In addition, the conversion reaction by which transition metal in the transition metal sulfide is replaced with lithium proceeds with difficulty when the temperature is excessively low. Conversely, although the reaction per se proceeds more rapidly when the temperature is excessively high, the positive electrode active material deteriorates due to the occurrence of other side reactions. Consequently, it is preferable for the temperature to be within a prescribed range during charge-discharge cycles.

<All-Solid-State Battery Precursor>

The production method of the present disclosure is a method for producing an all-solid-state battery that comprises assembling an all-solid-state battery precursor having a positive electrode active material layer, a solid electrolyte layer and a negative electrode active material layer in that order, followed by carrying out charge-discharge cycles on the all-solid-state battery precursor according to the conditions indicated below.

Although there are no particular limitations on the method used to assemble the all-solid-state battery precursor, examples thereof include a method consisting of laminating the positive electrode active material layer, solid electrolyte layer and negative electrode active material layer in that order to assemble an all-solid-state battery precursor.

Furthermore, there are no particular limitations on the method used to fabricate the positive electrode active material layer, sulfide solid electrolyte layer and negative electrode active material layer, and they can be fabricated according to any method known among persons with ordinary skill in the art. For example, the positive electrode active material layer can be fabricated using the fabrication method indicated below.

First, a positive electrode active material in the form of an olivine-type positive electrode material, a conductive assistant and a binder and the like are dispersed in a dispersion medium to fabricate a slurry. Subsequently, this slurry is coated onto metal foil and dried to obtain a powder for a positive electrode active material. This powder is then pressed to allow the obtaining of a positive electrode active material layer. Incidentally, the binder is not an essential constituent for producing the positive electrode active material layer.

In addition, another example of a method for fabricating the positive electrode active material layer consists of mixing positive electrode active material layer raw materials in a dispersion medium, coating onto metal foil and drying. Moreover, the positive electrode active material layer can be deposited on a metal substrate by spraying positive electrode active material layer raw materials thereon using, for example, an electrostatic spraying device.

Incidentally, the negative electrode active material layer and solid electrolyte layer can be fabricated using similar methods.

In addition, the positive electrode active material layer, sulfide solid electrolyte layer and negative electrode active material layer can be fabricated by employing the configurations and using the materials previously described in the section entitled <<All-Solid-State Battery of the Present Disclosure>>.

<Charge-Discharge Cycles>

The production method of the present disclosure comprises carrying out charge-discharge cycles in which the all-solid-state battery precursor is discharged until the electrical potential of the positive electrode active material layer reaches 2.1 V vs. Li/Li⁺ or lower while maintaining the temperature of the all-solid-state battery precursor at 25° C. to 80° C.

The lower limit discharge potential may be 2.1 V vs. Li/Li⁺ or lower, 2.0 V vs. Li/Li⁺ or lower, 1.9 V vs. Li/Li⁺ or lower, 1.8 V vs. Li/Li⁺ or lower, 1.7 V vs. Li/Li⁺ or lower, 1.6 V vs. Li/Li⁺ or lower or 1.5 V vs. Li/Li⁺ or lower.

In addition, the charge-discharge cycles of the production method of the present disclosure is preferably such that the all-solid-state battery precursor is discharged until the electrical potential of the positive electrode active material layer reaches the lower limit discharge potential of 1.6 V vs. Li/Li⁺ to 2.1 V vs. Li/Li⁺. If the lower limit discharge potential is excessively high, the resistive layer is unable to be adequately destroyed and battery capacity does not increase even if charge-discharge cycles are repeated, while conversely, if the lower limit discharge potential is excessively low, battery materials in the positive electrode active material layer react due to over-discharging, which is predicted to cause a decrease in capacity, increase in internal capacity or other factors causing deterioration of the positive electrode active material layer.

Moreover, this charge-discharge cycles preferably satisfies the conditions for temperature, charge-discharge rate, upper limit charging potential, lower limit discharge potential and/or the number of times and timing of the charge-discharge cycles as described below.

1. Temperature

The temperature of the all-solid-state battery precursor is preferably maintained at 25° to 80° C., and particularly preferably 40° C. to 80° C., during charge-discharge cycles of the production method of the present disclosure. This is because, by maintaining the temperature of the all-solid-state battery precursor within a certain temperature range during the charge-discharge cycles, the reaction for destroying the resistive layer formed between the olivine-type positive electrode active material and solid electrolyte during charging can be allowed to proceed efficiently. In addition, if the temperature is excessively low, the reaction for destroying the resistive layer does not proceed adequately and it becomes necessary to repeat charge-discharge cycles an extremely large number of times, thereby resulting in poor efficiency. Conversely, if the temperature is excessively high, other side reactions proceed resulting in deterioration of the positive electrode active material.

The temperature range is preferably 25° C. or higher, 30° C. or higher, 35° C. or higher, 40° C. or higher, 41° C. or higher, 42° C. or higher, 45° C. or higher or 50° C. or higher and 80° C. or lower, 75° C. or lower, 70° C. or lower, 65° C. or lower, 60° C. or lower or 55° C. or lower. The temperature is more preferably 42° C. to 60° C. in order to reduce side reactions while allowing the reaction for destroying the resistive layer to proceed.

2. Charge-Discharge Rate

The charge-discharge rate of charge-discharge cycles of the production method of the present disclosure is preferably 1.0 C or lower. If the charge-discharge rate is excessively high, since there is little reaction for destroying the resistive layer, charge-discharge cycles is required to be repeated for an extremely large number of times. Conversely, by making the charge-discharge rate low, the number of charge-discharge cycles required to remove the resistive layer can be reduced.

The charge-discharge rate may be 1.0 C or less, 0.7 C or less, 0.5 C or less, 0.1 C or less, 0.05 C or less or 0.02 C or less.

If the charge-discharge rate is high, the number of required charge-discharge cycles increases. On the other hand, if the charge-discharge rate is low, a single cycle requires considerable time. Thus, the charge-discharge rate is preferably 0.1 C to 0.5 C based on the balance between the required number of charge-discharge cycles and the amount of time required for a single cycle.

3. Upper Limit Potential

In the charge-discharge cycles of the production method of the present disclosure, the all-solid-state battery precursor is preferably charged until the electrical potential of the positive electrode active material layer reaches an upper limit charging potential of 3.8 V vs. Li/Li⁺ to 4.4 V vs. Li/Li⁺. This is because, if the upper limit charging potential is excessively high, side reactions end up proceeding and the positive electrode active material deteriorates.

The upper limit charging potential may be 3.8 V vs. Li/Li⁺ or higher, 4.0 V vs. Li/Li⁺ or higher or 4.1 v vs. Li/Li⁺ or higher, and 4.4 V vs. Li/Li⁺ or lower, 4.3 V vs. Li/Li⁺ or lower or 4.2 V vs. Li/Li⁺ or lower.

4. Number of Times and Timing of Charge-Discharge Cycles

In the production method of the present disclosure, charge-discharge cycles are preferably carried out for at least 3 cycles. This is because, following the formation of a resistive layer during initial charging, the resistive layer is subsequently destroyed by repeating several charge-discharge cycles. After three cycles, these charge-discharge cycles may be repeated or the all-solid-state battery precursor may be stored for 40 hours or more at 40° C. to 80° C. without charging and discharging. This is because the resistive layer is destroyed further by storing at 40° C. to 80° C.

In addition, these charge-discharge cycles may be carried out continuously or charge-discharge cycles may be carried out under different conditions in between this charge-discharge cycles. However, this charge-discharge cycling is preferably carried out continuously in order to produce the all-solid-state battery of the present discloser efficiently. In addition, from the same viewpoint, this charge-discharge cycles are preferably carried out from the time of initial charging and discharging, or in other words, from the start of charging and discharging.

5. Timing of Completion of Charge-Discharge Cycles

In the production method of the present disclosure, charge-discharge cycles are preferably repeated until the discharge capacity exceeds the discharge capacity of the initial charge-discharge cycle. In the production method of the present disclosure, battery discharge capacities during early charge-discharge cycles are lower than battery discharge capacities of the previous charge-discharge cycle as a principle.

The reason for this is thought to be as described below. Namely, during initial charge-discharge cycling, a resistive layer is formed at the interface between the positive electrode active material in the form of lithium iron phosphate and the sulfide solid electrolyte, and the reaction between the lithium iron phosphate and lithium ions during discharge is inhibited. However, in the method of the present disclosure, since this resistive layer is removed from the interface between the lithium iron phosphate and sulfide solid electrolyte as charge-discharge cycles are further repeated, the number of reactions between the lithium iron phosphate and lithium ions during discharge increases each time cycling is repeated. Thus, when the discharge capacity becomes greater than the discharge capacity during initial charge-discharge cycles in relation to this increase, the resistance layer can be said to have been adequately removed.

In addition, charge-discharge cycles are preferably carried out until a discharge plateau of the electrical potential of the positive electrode active material layer during discharge is no longer observed at 2.1 V vs. Li/Li⁺) to 2.5 V vs. Li/Li⁺. Sulfide of a transition metal derived from the olivine-type positive electrode active material contained in the resistive layer reacts with lithium ions at 2.1 V vs. Li/Li⁺ to 2.5 V vs. Li/Li⁺. In the case a discharge plateau is present within this electrical potential range, this indicates that a reaction is occurring between FeSₓ derived from the lithium iron phosphate and lithium ions. In other words, this indicates that a resistive layer is present at the interface between the lithium iron phosphate and the sulfide solid electrolyte.

In addition, charge-discharge cycles are preferably carried out until a discharge plateau of the electrical potential of the positive electrode active material layer during discharge appears at 3.3 V vs. Li/Li⁺ to 3.5 V vs. Li/Li⁺. Since the electrical potential of the reaction between the lithium iron phosphate and lithium ions is present at 3.3 V vs. Li/Li⁺ to 3.5 V vs. Li/Li⁺, the presence of a discharge plateau within this range indicates that the resistive layer at the interface between the lithium iron phosphate and sulfide solid electrolyte has been adequately removed.

The discharge plateau at 3.3 V vs. Li/Li⁺ to 3.5 V vs. Li/Li⁺ may be present over a range of discharge capacity of at least 10 mAh/g to 60 mAh/g, 10 mAh/g to 80 mAh/g, 10 mAh/g to 100 mAh/g, 10 mAh/g to 120 mAh/g or 10 mAh/g to 140 mAh/g. In addition, it is preferably present over a range of at least 10 mAh/g to 140 mAh/g. This is because a longer discharge plateau indicates that more of the lithium iron phosphate and lithium ions are reacting.

Furthermore, in the present description, a discharge plateau refers to a flat portion of a curve representing the relationship between voltage and discharge capacity where there are few changes in voltage versus changes in discharge capacity. More specifically, this refers to a portion where the rate of change in voltage (V) with respect to the rate of change in discharge capacity (Q) per unit weight of positive electrode active material (dV/dQ) is −0.010 (V/(mAh/g)) to 0.000 (V/(mAh/g)), and for example, −0.005 (V/(mAh/g)) to 0.000 (V/(mAh/g)). This discharge plateau may also be where the value of dV/dQ is −0.005 (V/(mAh/g)) to −0.003 (V/(mAh/g)).

### EXAMPLES

### Example 1 and Comparative Examples 1 and 2

All-solid-state batteries of Example 1 and Comparative Examples 1 and 2 were fabricated according to the methods described below. These all-solid-state batteries were subjected to cyclic voltammetry under the conditions indicated below.

### Example 1

### 1. Fabrication of All-Solid-State Battery

(1) Fabrication of Positive Electrode Active Material Layer

Lithium ethoxide, cobalt nitrate and phosphoric acid were dissolved in a solution obtained by mixing dehydrated ethanol and butyl carbitol at a volume ratio of 1:2 to prepare a solution 1 for depositing a positive electrode active material layer. The solution 1 for depositing a positive electrode active material layer was placed in an electrostatic spraying device followed by spraying onto a platina substrate to deposit a thin film under conditions of an applied voltage of 15,000 V, flow rate of 50 μL/min and substrate temperature of 300° C.

The resulting thin film was subjected to annealing treatment in air for 5 hours at 600° C. to fabricate a layer of LiCoPO₄ as a first positive electrode active material on a platina substrate as a positive electrode current collector.

Next, lithium ethoxide, iron nitrate and phosphoric acid were dissolved in a solution obtained by mixing dehydrated ethanol and butyl carbitol at a volume ratio of 1:2 to prepare a solution 2 for depositing a positive electrode material layer. The solution 2 for depositing a positive electrode active material layer was placed in an electrostatic spraying device followed by spraying onto the platina substrate deposited with the LiCoPO₄ layer to deposit a thin film thereon under conditions of an applied voltage of 15,000 V, flow rate of 50 μL/min and substrate temperature of 200° C.

The resulting thin film was subjected to annealing treatment in air for 5 hours at 500° C. to fabricate a positive electrode active material layer having a layer of LiFePO₄ as second active material on the platina substrate deposited with the LiCoPO₄ layer.

(2) Fabrication of Solid Electrolyte Layer

75Li₂S-25P₂S₅ as a sulfide solid electrolyte, a binder and dehydrated heptane as a dispersion medium were mixed well to prepare a slurry for a solid electrolyte layer. This slurry for a solid electrolyte layer was coated onto aluminum foil and dried to fabricate a solid electrolyte layer.

(3) Fabrication of Negative Electrode Active Material Layer

Lithium ethoxide, titanium nitrate and phosphoric acid were dissolved in a solution obtained by mixing dehydrated ethanol and butyl carbitol at a volume ratio of 1:2 to prepare a solution for depositing a negative electrode active material layer. The solution for depositing a negative electrode active material layer was placed in an electrostatic spraying device followed by spraying onto a platina substrate as a negative electrode current collector to deposit a thin film under conditions of an applied voltage of 15,000 V, flow rate of 50 μL/min and substrate temperature of 300° C.

(4) Battery Assembly

The positive electrode current collector, positive electrode active material layer, solid electrolyte layer, negative electrode active material layer and negative electrode current collector were laminated in that order to assemble the all-solid-state battery of Example 1.

### 2. Cyclic Voltammetry

A cyclic voltammetry measuring instrument was connected between the negative electrode current collector and positive electrode current collector of the all-solid-state battery of Example 1 and charge-discharge cycles were repeated 15 times from 0 V to 2.5 V (electrical potential of positive electrode active material layer from 1.6 V vs. Li/Li⁺ to 4.1 vs. Li/Li⁺) to measure cyclic voltammetry. Subsequently, cyclic voltammetry was measured from 0 V to 4.5 V (electrical potential of positive electrode active material layer from 1.6 V vs. Li/Li⁺ to 6.1 vs. Li/Li⁺). Furthermore, the sweep rate during CV measurement was set to 2 mV/s.

### 3. Results and Discussion

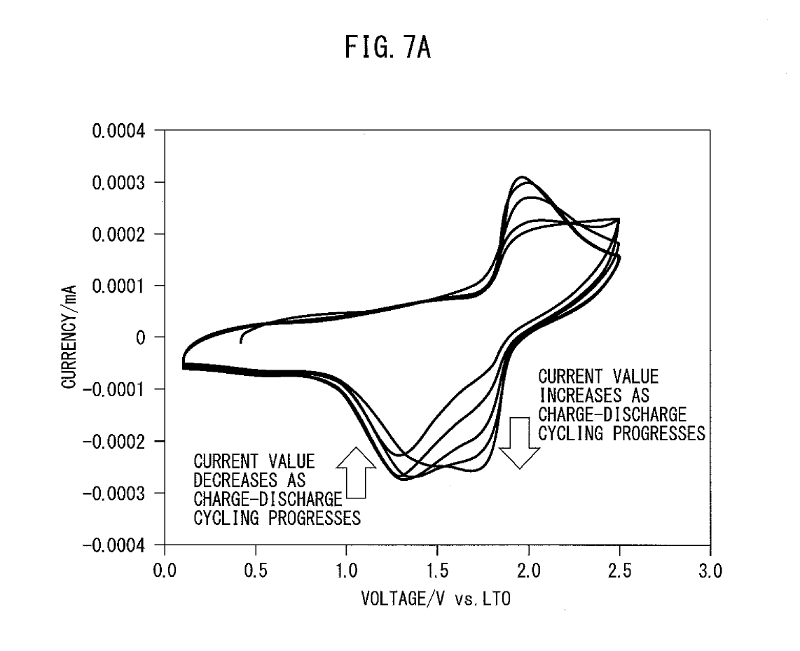

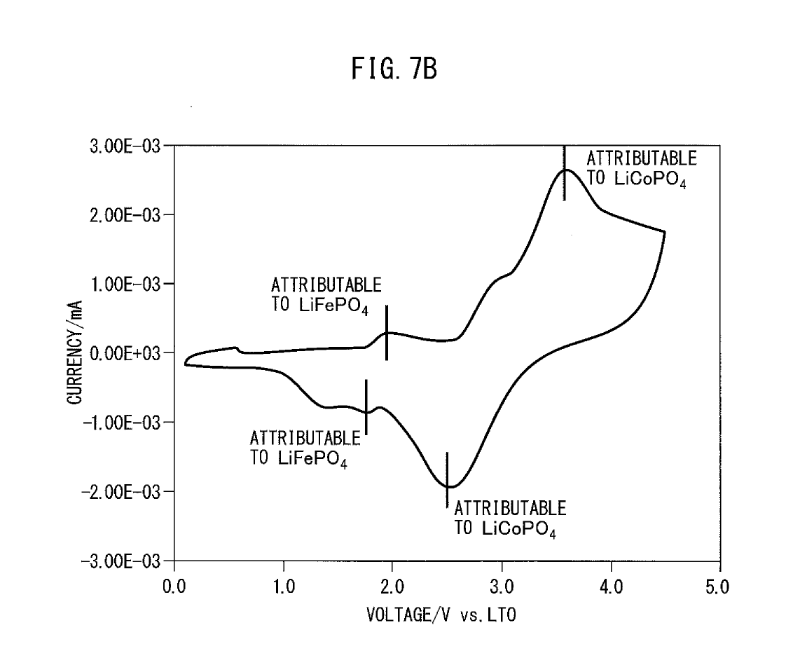

The results of cyclic voltammetry are shown in FIGS. 7A and 7B. FIG. 7A indicates the results of cyclic voltammetry consisting of repeating 15 cycles of charge-discharge cycles from 0 V to 2.5 V (electrical potential of positive electrode active material layer from 1.6 V vs. Li/Li⁺ to 4.1 vs. Li/Li⁺). FIG. 7B indicates the results of cyclic voltammetry after 15 cycles.

As shown in FIG. 7A, as a result of having carried out charge-discharge cycles from 0 V to 2.5 V on the all-solid-state battery of Example 1, the reduction peak at 1.8 V (electrical potential of positive electrode active material layer of 3.4 V vs. Li/Li⁺) increased as charge-discharge cycles were repeated, while the reduction peak in the vicinity of 0.5 V to 1.4 V (electrical potential of positive electrode active material layer from 2.1 V vs. Li/Li⁺ to 3.0 vs. Li/Li⁺) decreased. The reduction peak in the vicinity of 1.8 V is thought to be attributable to the insertion of lithium ions into LiFePO₄, while the reduction peak in the vicinity of 0.5 V to 1.4 V is thought to be attributable to the reaction between the resistive layer and lithium ions.

On the basis thereof, a resistive layer formed on the surface of LiFePO₄ is thought to have been destroyed by carrying out charge-discharge cycles from 0 V to 2.5 V (electrical potential of positive electrode active material layer from 1.6 V vs. Li/Li⁺ to 4.1 vs. Li/Li⁺).

Subsequently, as shown in FIG. 7B, after having repeated 15 cycles of charge-discharge cycles from 0 V to 2.5 V, an oxidation peak in the vicinity of 3.5 V and a reduction peak in the vicinity of 2.5 V were confirmed when charging and discharging were carried out from 0 V to 4.5 V. These peaks indicate that reactions involving insertion and dissociation of lithium ions were respectively occurring with respect to the LiCoPO₄.

In this manner, LiCoPO₄ can be allowed to act in a sulfide all-solid-state battery by laminating LiFePO₄ on the surface of the LiCoPO₄ and destroying the resistive layer formed on the surface of the LiFePO₄.

### Comparative Example 1

### 1. Fabrication of All-Solid-State Battery

Lithium ethoxide, iron nitrate, cobalt nitrate and phosphoric acid were dissolved in a solution obtained by mixing dehydrated ethanol and butyl carbitol at a volume ratio of 1:2 to prepare a solution 3 for depositing a positive electrode active material layer. The solution 3 for depositing a positive electrode active material layer was placed in an electrostatic spraying device followed by spraying onto a platina substrate to deposit a thin film under conditions of an applied voltage of 15,000 V, flow rate of 50 μL/min and substrate temperature of 300° C. Incidentally, the volume ratio of the dissolved iron nitrate to cobalt nitrate was 1:4.

The resulting thin film was subjected to annealing treatment in air for 5 hours at 600° C. to fabricate a layer consisting of a mixture of LiFePO₄ and LiCoPO₄ on a positive electrode current collector in the form of the platina substrate.

The all-solid-state battery of Comparative Example 1 was then fabricated using the same conditions as Example 1 for the other conditions.

### 2. Cyclic Voltammetry

A cyclic voltammetry measuring instrument was connected between the negative electrode current collector and positive electrode current collector of the all-solid-state battery of Comparative Example 1 and charge-discharge cycles were repeated 2 times from 0 V to 4.5 V (electrical potential of positive electrode active material layer from 1.6 V vs. Li/Li⁺ to 6.1 vs. Li/Li⁺) to measure cyclic voltammetry. Furthermore, the sweep rate during CV measurement was set to 2 mV/s.

### 3. Results and Discussion

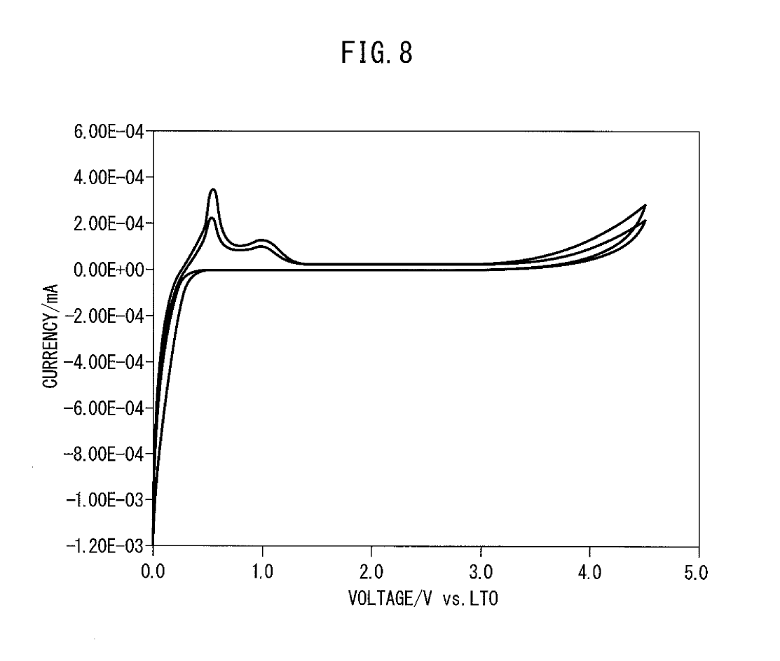

The results of cyclic voltammetry are shown in FIG. 8. As shown in the drawing, in the case of the all-solid-state battery of Comparative Example 1 having a layer consisting of a mixture of LiFePO₄ and LiCoPO₄, battery operation was unable to be confirmed. This is thought to be due to the occurrence of side reactions where the LiCoPO₄ contacts the sulfide solid electrolyte, thereby resulting in the formation of a resistive layer on the surface of the positive electrode active material layer.

### Comparative Example 2

### 1. Fabrication of All-Solid-State Battery

Lithium ethoxide, cobalt nitrate and phosphoric acid were dissolved in a solution obtained by mixing dehydrated ethanol and butyl carbitol at a volume ratio of 1:2 to prepare a solution 4 for depositing a positive electrode active material layer. The solution 4 for depositing a positive electrode active material layer was placed in an electrostatic spraying device followed by spraying onto a platina substrate to deposit a thin film under conditions of an applied voltage of 15,000 V, flow rate of 50 μL/min and substrate temperature of 300° C.

The resulting thin film was subjected to annealing treatment in air for 5 hours at 600° C. to fabricate positive electrode active material layer having only LiCoPO₄ for the positive electrode active material on a platina substrate as a positive electrode current collector.

The all-solid-state battery of Comparative Example 2 was then fabricated using the same conditions as Example 1 for the other conditions.

### 2. Cyclic Voltammetry

A cyclic voltammetry measuring instrument was connected between the negative electrode current collector and positive electrode current collector of the all-solid-state battery of Comparative Example 2 and charge-discharge cycles were repeated 4 times from 0 V to 4.5 V (electrical potential of positive electrode active material layer from 1.6 V vs. Li/Li⁺ to 6.1 vs. Li/Li⁺) to measure cyclic voltammetry. Incidentally, the sweep rate during CV measurement was set to 2 mV/s.

### 3. Results and Discussion

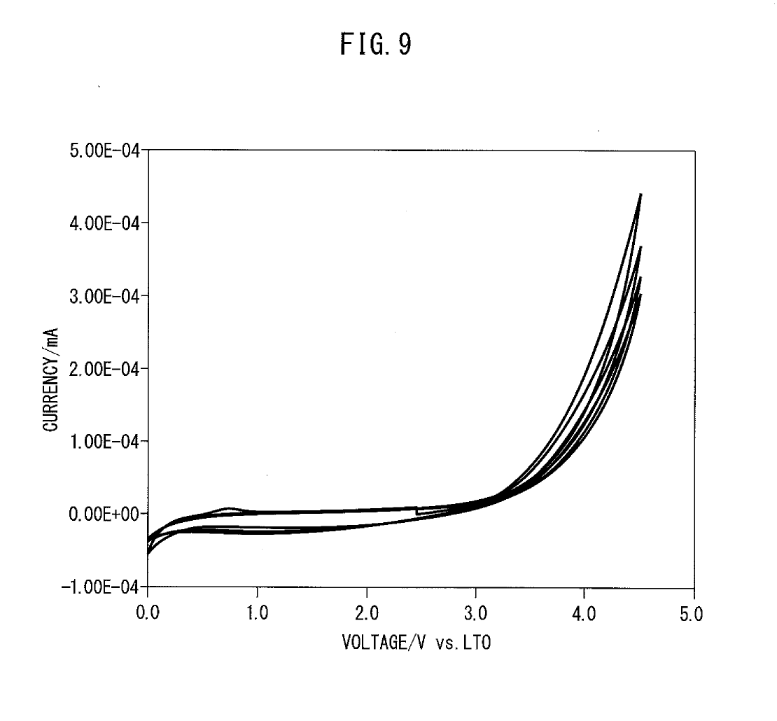

The results of cyclic voltammetry are shown in FIG. 9. As shown in the drawing, in the case of the all-solid-state battery of Comparative Example 2 having a positive electrode active material layer consisting only of LiCoPO₄, battery operation was unable to be confirmed even after repeating a certain number of charge-discharge cycles. On the basis thereof, a possible reason for this is thought to be either that, although a resistive layer was formed on the surface of the positive electrode active material layer due to the occurrence of side reactions where a LiCoPO₄ as the positive electrode active material contacts the sulfide electrolyte layer, resistive layer was unable to be removed by subsequent charge-discharge cycles, or a coating layer was unable to be formed.

### Reference Examples 1 to 17

All-solid-state batteries were fabricated in the manner indicated below and charge-discharge cycles were repeated under certain conditions in order to examine conditions enabling optimum removal of a resistive film formed between the lithium iron phosphate and sulfide solid electrolyte.

<Fabrication of all-Solid-State Batteries>

1. Fabrication of Powder for Positive Electrode Active Material Layer

LiFePO₄ having a carbon coating as a positive electrode active material, vapor-grown carbon fibers (VGCF) as a conductive assistant, Li₃PS₄—LiI—LiBr as a sulfide solid electrolyte, butyl butyrate as a dispersion medium, and vinylidene fluoride (PVDF) as a binder were weighed out and mixed well to fabricate a slurry for the positive electrode active material layer. This slurry for the positive electrode active material layer was coated onto aluminum foil and dried to obtain a powder for the positive electrode active material layer.

2. Fabrication of Powder for Negative Electrode Active Material Layer

Li₄Ti₅O₁₂ (LTO) as a negative electrode active material, VGCF as a conductive assistant, Li₃PS₄—LiI—LiBr as a sulfide solid electrolyte, butyl butyrate as a dispersion medium, and PVDF as a binder were weighed out and mixed well to fabricate a slurry for the negative electrode active material layer. This slurry for the negative electrode active material layer was coated onto aluminum foil and dried to obtain a powder for the negative electrode active material layer.

3. Fabrication of Solid Electrolyte Layer

Sulfide solid electrolyte, binder and dehydrated heptane as dispersion medium were mixed well to fabricate a slurry for the solid electrolyte layer. This slurry for the solid electrolyte layer was coated onto aluminum foil and dried to obtain a solid electrolyte layer.

4. Battery Assembly

The solid electrolyte layer was pressed followed by placing a prescribed weighed amount of the powder for the positive electrode active material layer thereon and pressing to form the positive electrode active material layer. A prescribed amount of the powder for the negative electrode active material layer was weighed out and pressed to form the negative electrode active material layer. The negative electrode active material layer was then laminated on the solid electrolyte layer of the positive electrode active material layer followed by assembling into an all-solid-state battery by binding together with a jig.

<Charge-Discharge Cycles>

Charge-discharge cycles were repeated on the all-solid-state batteries fabricated according to the aforementioned method under the conditions for the lower limit discharge potential, upper limit charging potential, charge-discharge rate and temperature shown in the following Table 1. The relationships between battery voltage, battery capacity and discharge capacity during charge-discharge cycles were measured. In the following description, discharge capacity is indicated as battery capacity.

TABLE 1

| | Production Conditions | | | | Results | | |
|---|---|---|---|---|---|---|---|
| | Lower Limit Discharge | Upper Limit Charging | Charge-discharge | Tempera- | Final Discharge | | |
| | Potential (V vs. Li/Li⁺) | Potential (V vs. Li/Li⁺) | Rate (C) | ture (° C.) | Capacity (mAh/g) | Effect | Drawing |
| Reference | 1.6 | 4.1 | 0.1 | 60 | 175 | OK | 13A |
| Example 1 | | | | | | | |
| Reference | 2.1 | 4.1 | 0.1 | 60 | 155 | OK | 13B |
| Example 2 | | | | | | | |
| Reference | 2.3 | 4.1 | 0.1 | 60 | 10 | NG | 13C |
| Example 3 | | | | | | | |
| Reference | 1.6 | 3.8 | 0.1 | 60 | 168 | OK | 12A |
| Example 4 | | | | | | | |
| Reference | 1.6 | 4.1 | 0.1 | 60 | 175 | OK | 12B |
| Example 5 | | | | | | | |
| Reference | 1.6 | 4.4 | 0.1 | 60 | 175 | OK | 12C |
| Example 6 | | | | | | | |
| Reference | 1.6 | 4.7 | 0.1 | 60 | 205 | C/P¹ | 12D |
| Example 7 | | | | | | | |
| Reference | 1.6 | 4.1 | 0.02 | 60 | 175 | OK | 11A |
| Example 8 | | | | | | | |
| Reference | 1.6 | 4.1 | 0.05 | 60 | 168 | OK | 11B |
| Example 9 | | | | | | | |
| Reference | 1.6 | 4.1 | 0.1 | 60 | 175 | OK | 11C |
| Example 10 | | | | | | | |
| Reference | 1.6 | 4.1 | 0.5 | 60 | 160 | OK | 11D |
| Example 11 | | | | | | | |
| Reference | 1.6 | 4.1 | 1 | 60 | 145 | OK | 11E |
| Example 12 | | | | | | | |
| Reference | 1.6 | 4.1 | 0.1 | 25 | 138 | C/P | 10A |
| Example 13 | | | | | | | |
| Reference | 1.6 | 4.1 | 0.1 | 42 | 165 | OK | 10B |
| Example 14 | | | | | | | |
| Reference | 1.6 | 4.1 | 0.1 | 60 | 175 | OK | 10C |
| Example 15 | | | | | | | |
| Reference | 1.6 | 4.1 | 0.1 | 80 | 110 | OK | 10D |
| Example 16 | | | | | | | |
| Reference | 1.6 | 4.1 | 0.1 | 100 | 25 | NG | 10E |
| Example 17 | | | | | | | |

¹C/P: Conditionally Passed

1. Explanation of Table

As shown in Table 1, Reference Examples 1 to 3 indicate cases in which charge-discharge cycles were repeated while changing only the lower limit discharge potential and holding temperature, charge-discharge rate and upper limit charging potential constant. In addition, Reference Examples 4 to 7 indicate cases in which charge-discharge cycles were repeated while changing only the upper limit charging potential and holding temperature, charge-discharge rate and lower limit discharge potential constant. In addition, Reference Examples 8 to 12 indicate cases in which charge-discharge cycles were repeated while changing only the charge-discharge rate and holding temperature, upper limit charging potential and lower limit discharge potential constant. In addition, Reference Examples 13 to 17 indicate cases in which charge-discharge cycles were repeated while changing only the temperature and holding charge-discharge rate, upper limit charging potential and lower limit discharge potential constant.

In addition, in Table 1, “Effect” refers to an assessment of whether or not discharge capacity increased as a result of repeating charge-discharge cycles. A “OK” in the “Effect” column indicates the case in which discharge capacity was able to be increased, while a “NG” mark indicates the case in which discharge capacity was unable to be increased. In addition, a “C/P” mark indicates the case in which, although discharge capacity increased as a result of repeating charge-discharge cycles, there were an excessively large number of side reactions (Reference Example 7), or even through discharge capacity increases as a result of repeating charge-discharge cycles, discharge capacity does not adequately increase unless charge-discharge cycles are carried out for an extremely large number of cycles (Reference Example 13).

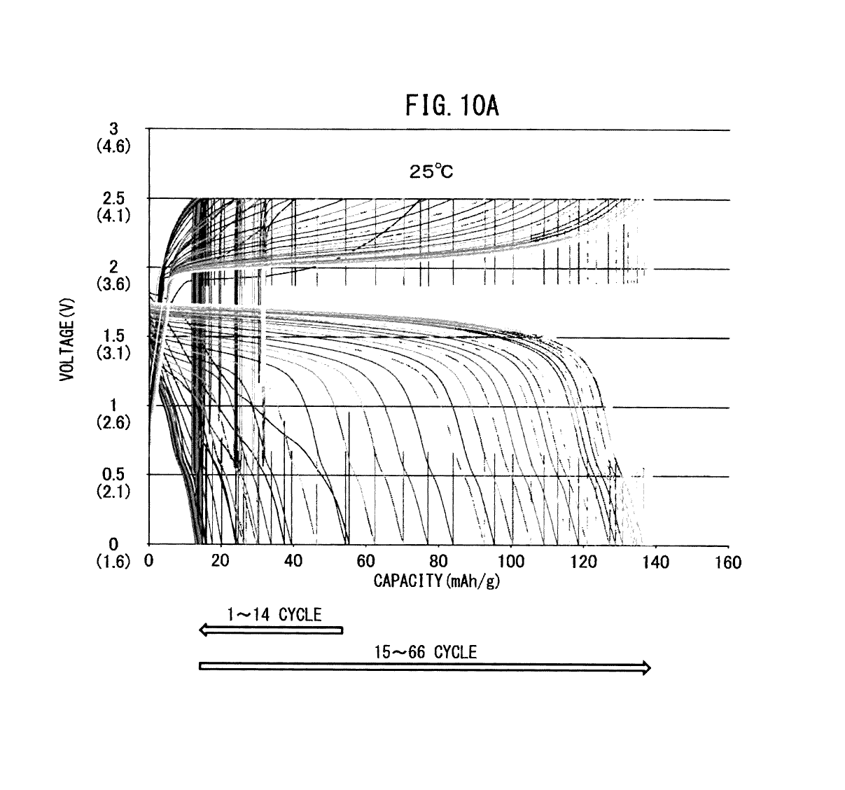

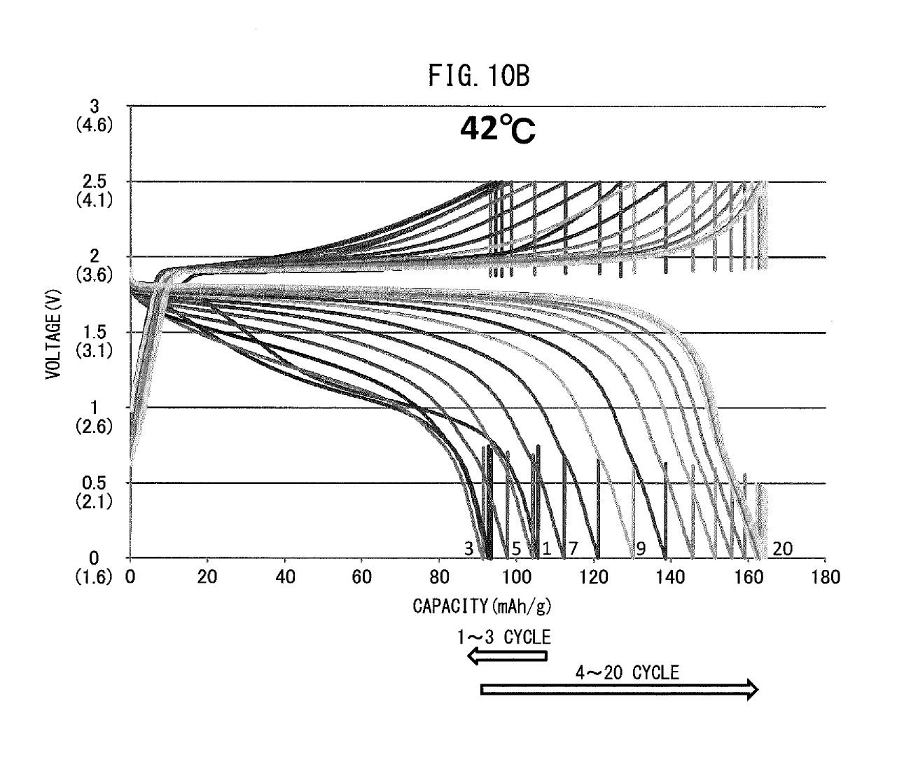

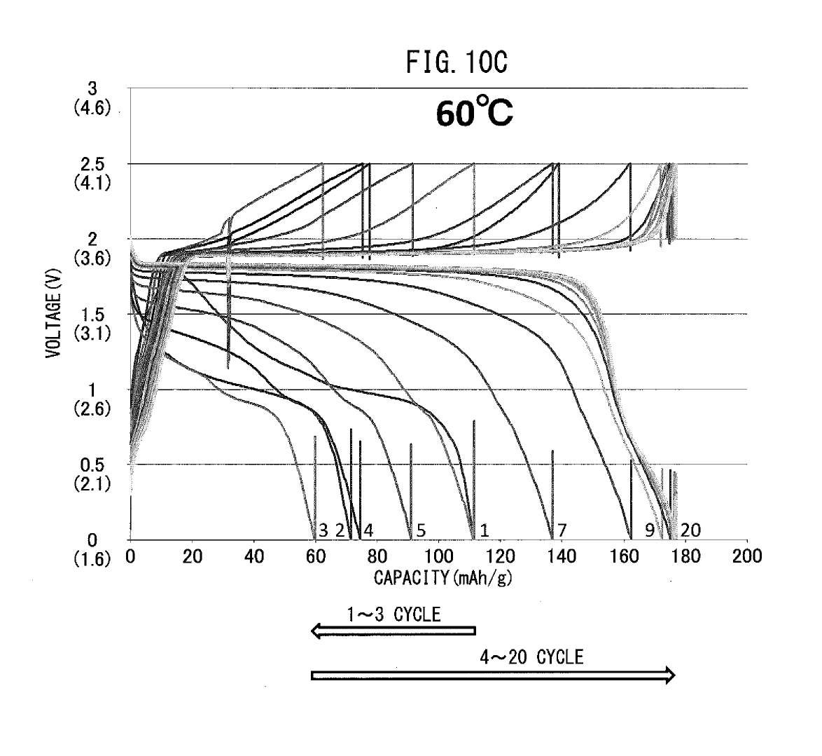

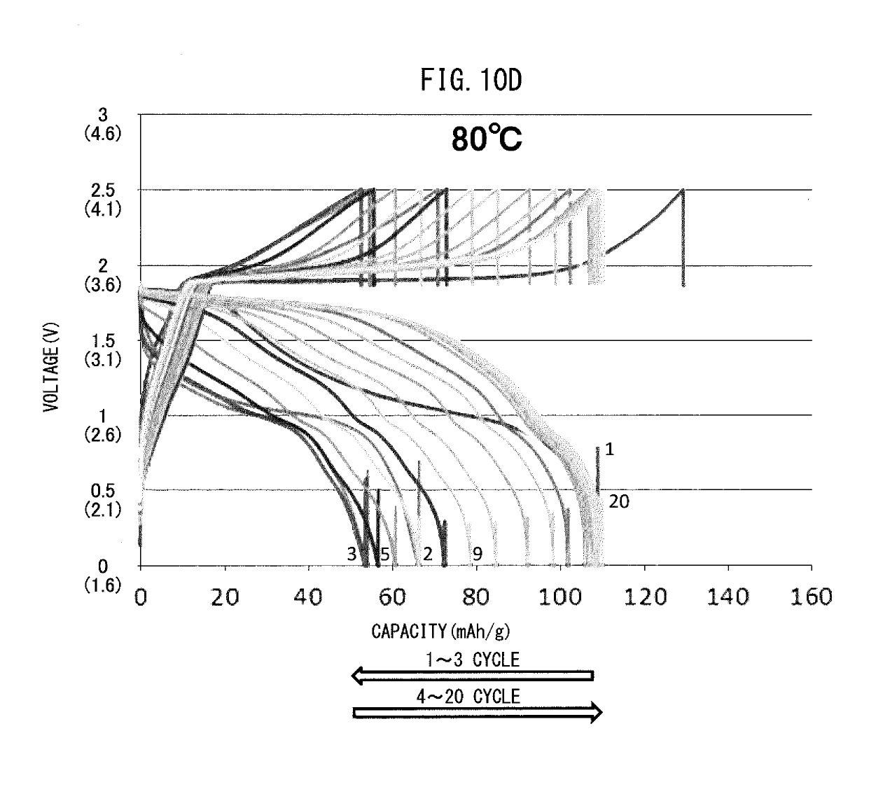

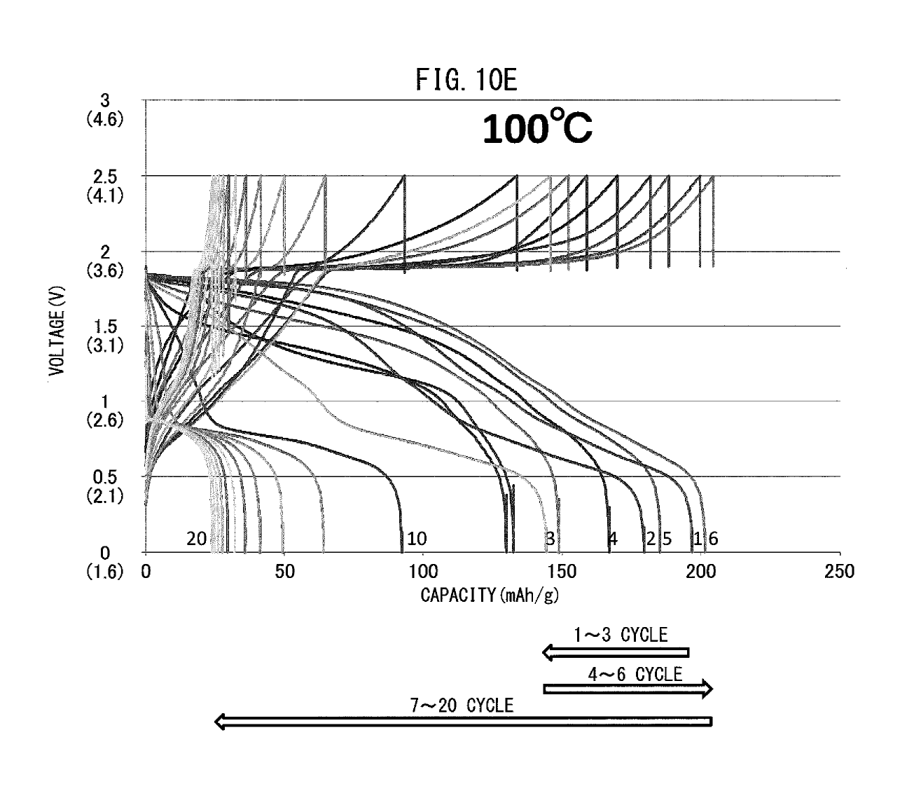

In addition, in Table 1, “Drawing” indicates the drawing representing the relationship between battery voltage, charging capacity and battery capacity in the case of having repeated charge-discharge cycles according to each condition. In FIGS. 10A to 13C, voltage is described as the electrical potential with respect to the electrical potential of the reaction between LTO and lithium ions in the case of using LTO for the negative electrode active material (V vs. LTO). In contrast, in the present description, it should be understood that voltage is described as the electrical potential with respect to the deposition voltage of lithium metal (V vs. Li/Li⁺). The electrical potential of the reaction between LTO and lithium ions (V vs. LTO) can be converted to the electrical potential with respect to the deposition potential of lithium metal (V vs. Li/Li⁺) by adding a voltage of 1.6 V. In FIGS. 10A to 13C, the electrical potential with respect to the deposition potential of lithium metal (V vs. Li/Li⁺) is described in parentheses below the electrical potential (V vs. Li/Li⁺) with respect to the electrical potential of the reaction between LTO and lithium ions (V vs. LTO). Furthermore, in FIGS. 10A to 13C, battery capacity is the capacity per unit weight of the positive electrode active material.

2. Results

(1) Lower Limit Discharge Potential (Reference Examples 1 to 3)

With respect to Reference Examples 1 to 3, charge-discharge cycles were repeated while maintaining the lower limit discharge potential of the all-solid-state batteries at 1.6 V vs. Li/Li⁺, 2.1 V vs. Li/Li⁺ and 2.3 V vs. Li/Li⁺, respectively. As a result, with respect to Reference Examples 1 and 2, although battery capacity decreased during the first few cycles, as a result of subsequently further repeating charging and discharging for up to 20 cycles, all-solid-state batteries having a large battery capacity were able to be obtained. In contrast, in Reference Example 3, battery voltage did not increase despite repeating charge-discharge cycles, and an all-solid-state battery having a large battery capacity was unable to be obtained.

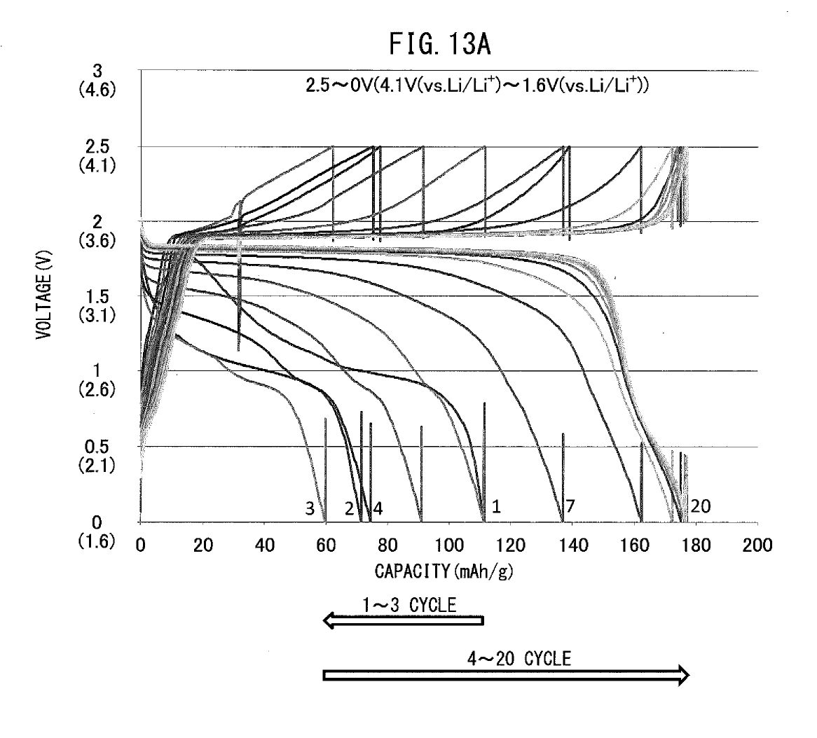

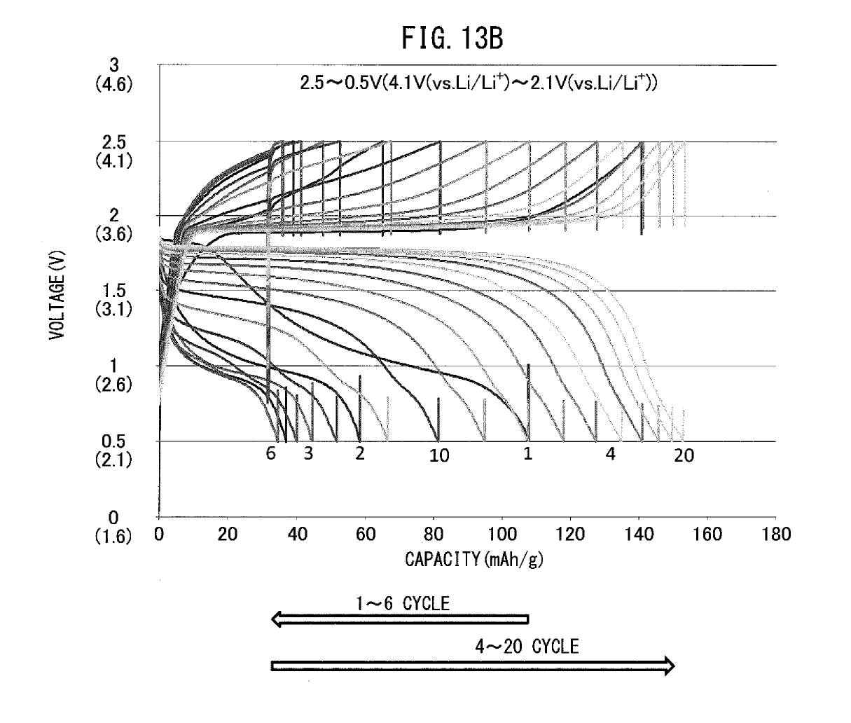

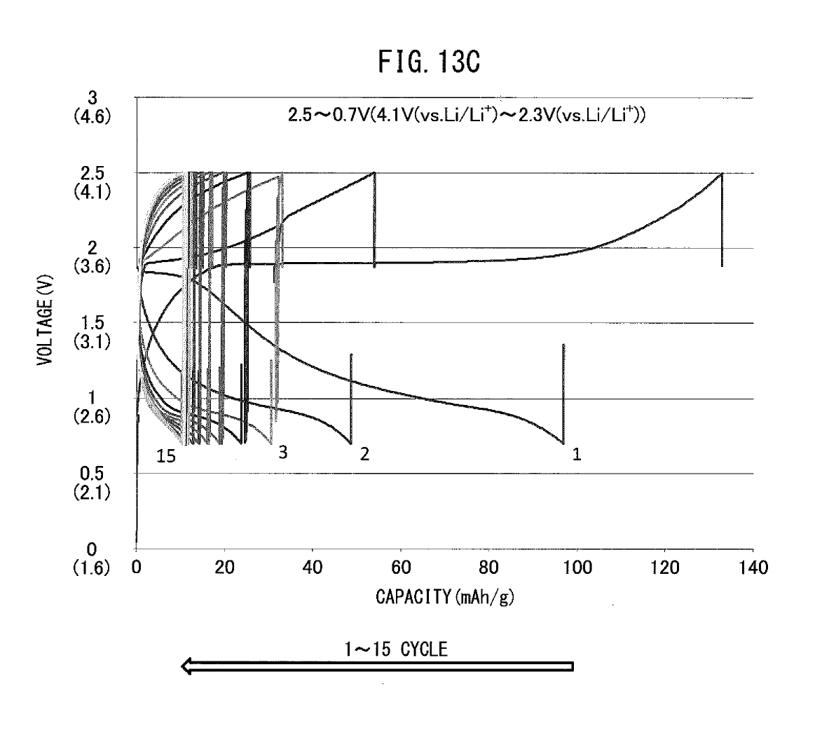

In FIGS. 13A and 13B, reaction plateaus are sufficiently present at 2.1 V vs. Li/Li⁺ to 2.5 V vs. Li/Li⁺. In contrast, in FIG. 13C, although a reaction plateau is observed at 2.1 V vs. Li/Li⁺ to 2.5 V vs. Li/Li⁺, discharge ends partway through the reaction plateau. This is thought to indicate that, in contrast to the resistive layer having been adequately destroyed in Reference Examples 1 and 2, in which the all-solid-state batteries discharged to a voltage lower than the electrical potential of 2.1 V vs. Li/Li⁺ to 2.5 V vs. Li/Li+ of the reaction between lithium ions and the resistive layer in the form of iron sulfide, the resistive layer was not sufficiently destroyed in Reference Example 3, in which the all-solid-state battery only discharged to 2.3 V.

(2) Upper Limit Charging Potential (Reference Examples 4 to 7)

With respect to Reference Examples 4 to 7, charge-discharge cycles were repeated for the fabricated all-solid-state batteries at an upper limit charging potential of 3.8 V vs. Li/Li⁺, 4.1 V vs. Li/Li⁺, 4.4 V vs. Li/Li⁺ and 4.7 V vs. Li/Li⁺, respectively. As a result, in the case of having carried out charge-discharge cycles in Examples 4 to 6, namely at an upper limit charging potential of 3.8 V vs. Li/Li⁺ to 4.4 V vs. Li/Li⁺, all-solid-state batteries were obtained having battery capacity of 160 mAh/g to 175 mAh/g that approached the theoretical capacity of LiFePO₄. In contrast, in the case of having repeated charge-discharge cycles at 4.7 V vs. Li/Li⁺ in the manner of Reference Example 7, the battery capacity of 200 mAh/g was larger than the theoretical capacity of LiFePO₄.

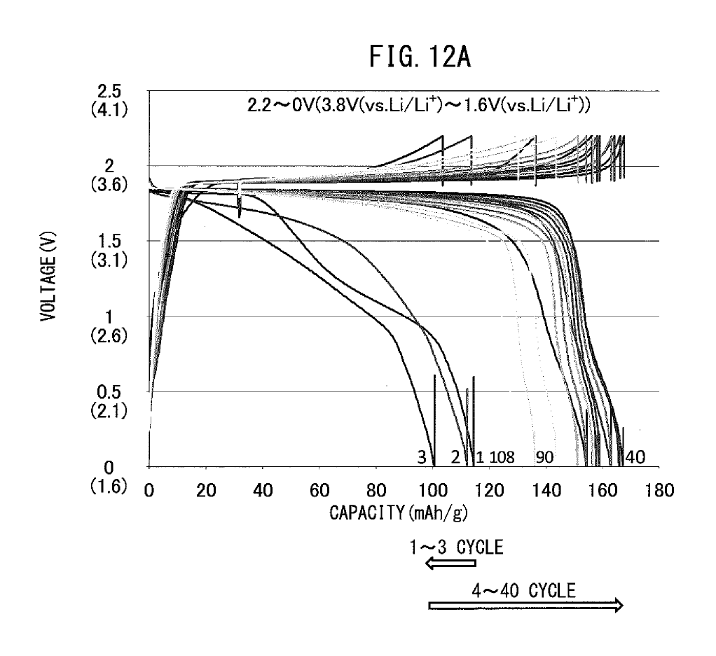

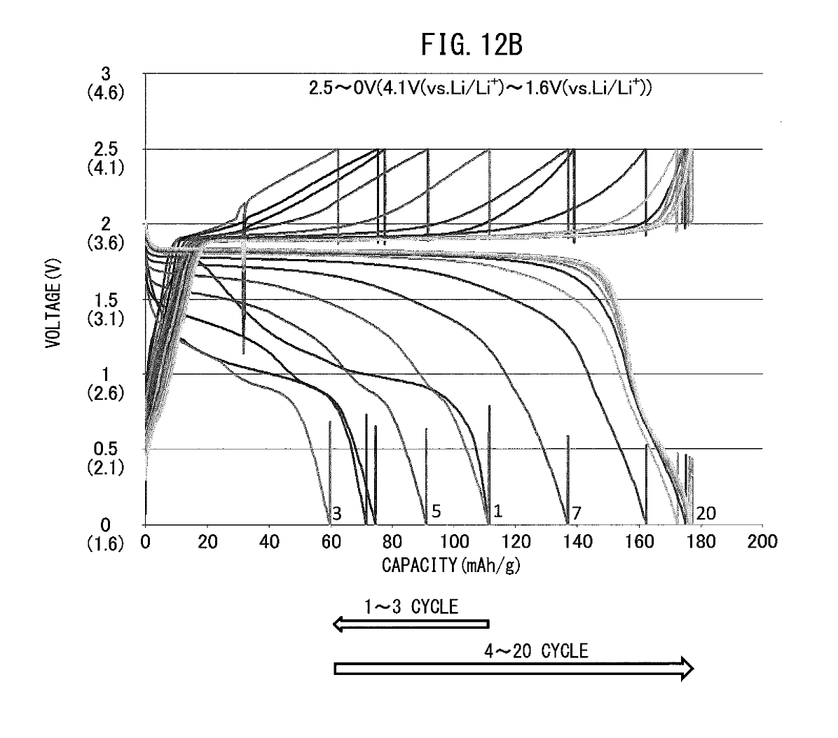

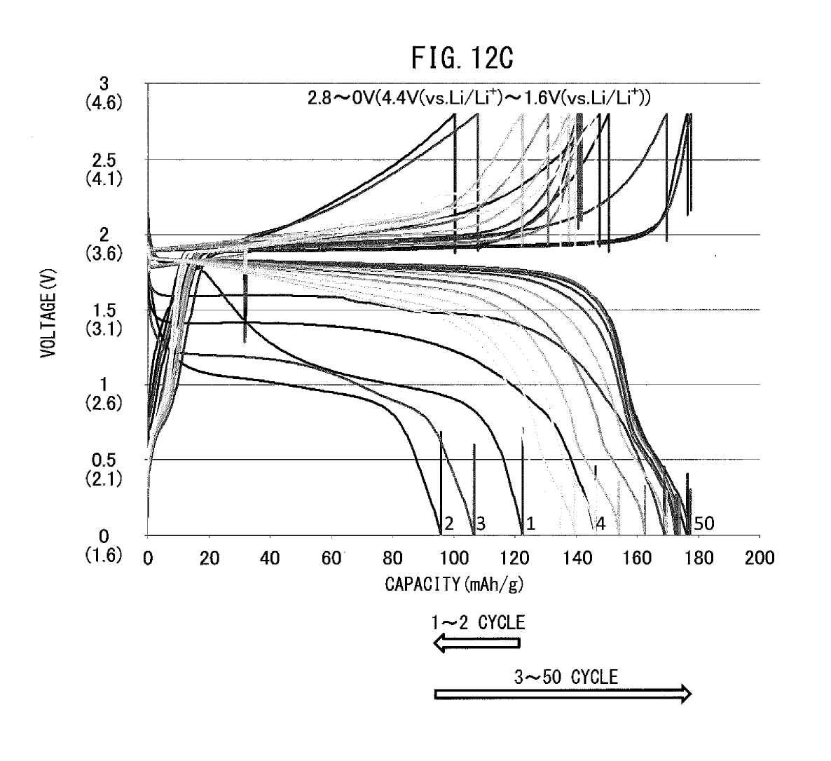

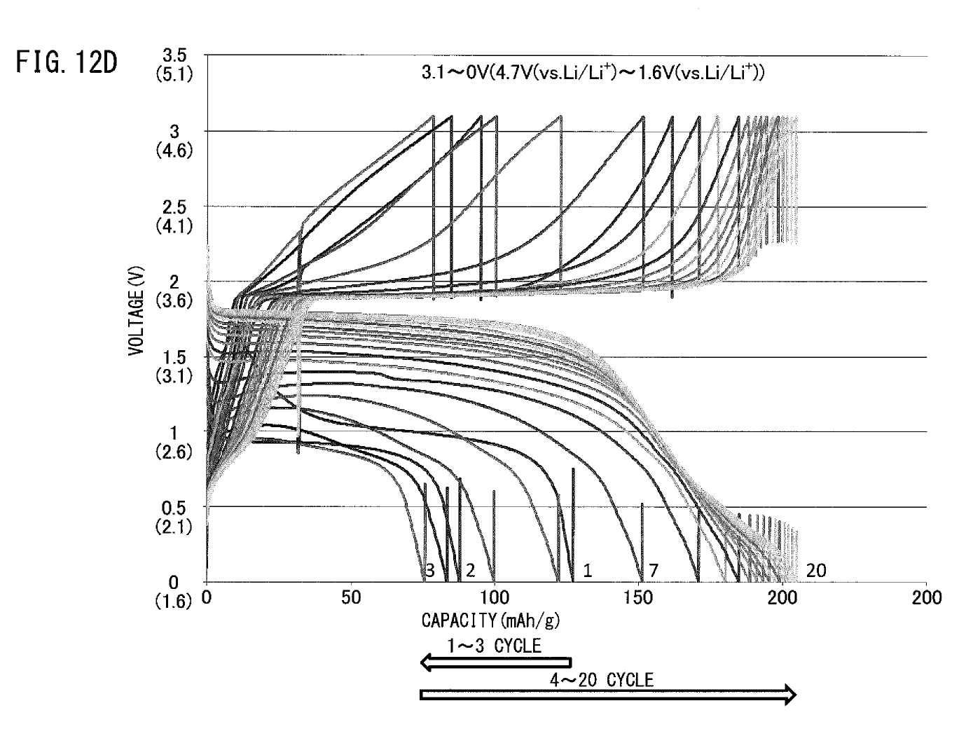

In the case of Reference Examples 4 to 6 in which charge-discharge cycles were carried out at an upper limit charging potential of 3.8 V vs. Li/Li⁺ to 4.4 V vs. Li/Li⁺ as in FIGS. 12A to 12C, battery capacity decreased during the first several cycles, and potential plateaus appeared in the vicinity of 2.1 V vs. Li/Li⁺ to 2.5 V vs. Li/Li⁺. Subsequently, as a result of repeating charge-discharge cycles, the potential plateaus in the vicinity of 2.1 V vs. Li/Li⁺ to 2.5 V vs. Li/Li⁺ were no longer observed, potential plateaus appeared at 3.3 V vs. Li/Li⁺ to 3.5 V vs. Li/Li⁺, and battery capacity increased. When a comparison is made among FIGS. 12A to 12C, as the upper limit charging potential became higher, there was an increase in the number of charge-discharge cycles required until the appearance of a potential plateau at 3.3 V vs. Li/Li⁺ to 3.5 V vs. Li/Li⁺. This is thought to be due to side reactions occurring more significantly as the upper limit potential became higher.

In the case of Reference Example 7, in which charge-discharge cycles were carried out at an upper limit charging potential of 4.7 V vs. Li/Li⁺ as shown in FIG. 12D, battery capacity decreased during the first several cycles and battery capacity increased as a result of subsequently repeating charge-discharge cycles in the same manner as Reference Examples 4 to 6. However, battery capacity was greater than the theoretical capacity of LiFePO₄ after 20 cycles. In addition, the potential plateau at 3.3 V vs. Li/Li⁺ to 3.5 V vs. Li/Li⁺ was shorter. This indicates that numerous side reactions were occurring in Reference Example 7.

(3) Charge-Discharge Rate (Reference Examples 8 to 12)

The all-solid-state batteries fabricated in Reference Examples 8 to 12 were repeatedly subjected to charge-discharge cycles while maintaining a charge-discharge rate of 0.02 C, 0.05 C, 0.1 C. 0.5 C or 1.0 C, respectively. As a result, large battery capacities were obtained in all cases. In the case of a charge-discharge rate of 0.5 C or less in particular, namely in the case of Reference Examples 8 to 11, all-solid-state batteries were obtained that had battery capacity of 160 mAh/g to 175 mAh/g, closely approximating the theoretical capacity of LiFePO₄. In the case of carrying out charge-discharge cycles at a charge-discharge rate of 1.0 C, namely in the case of Reference Example 12, a larger number of charge-discharge cycles was required in comparison with the other cases. However, an all-solid-state battery was able to be obtained that had high battery capacity of about 145 mAh/g.

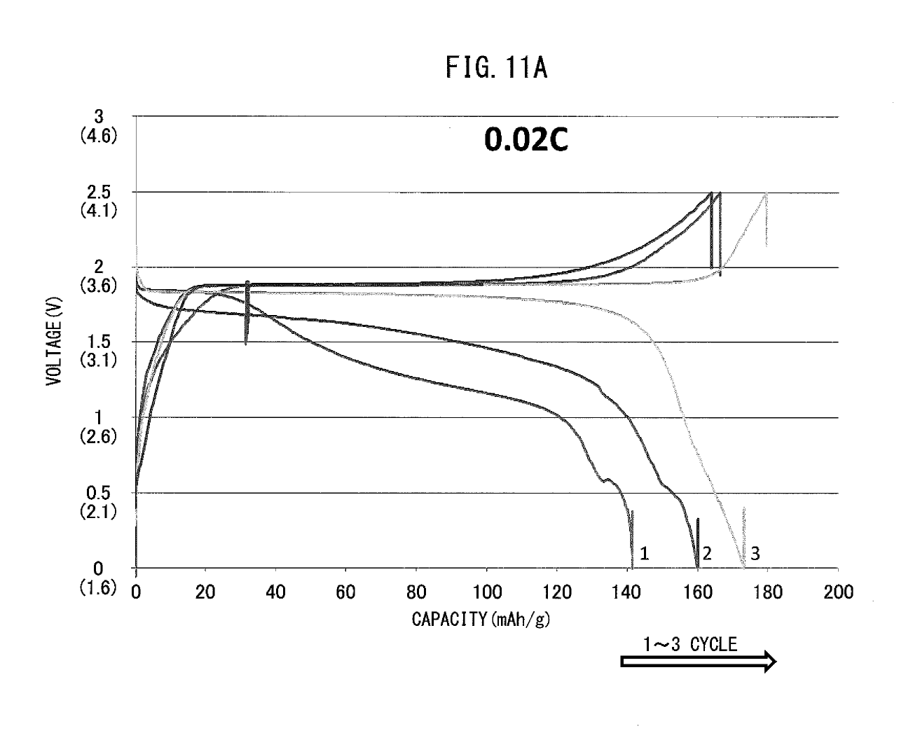

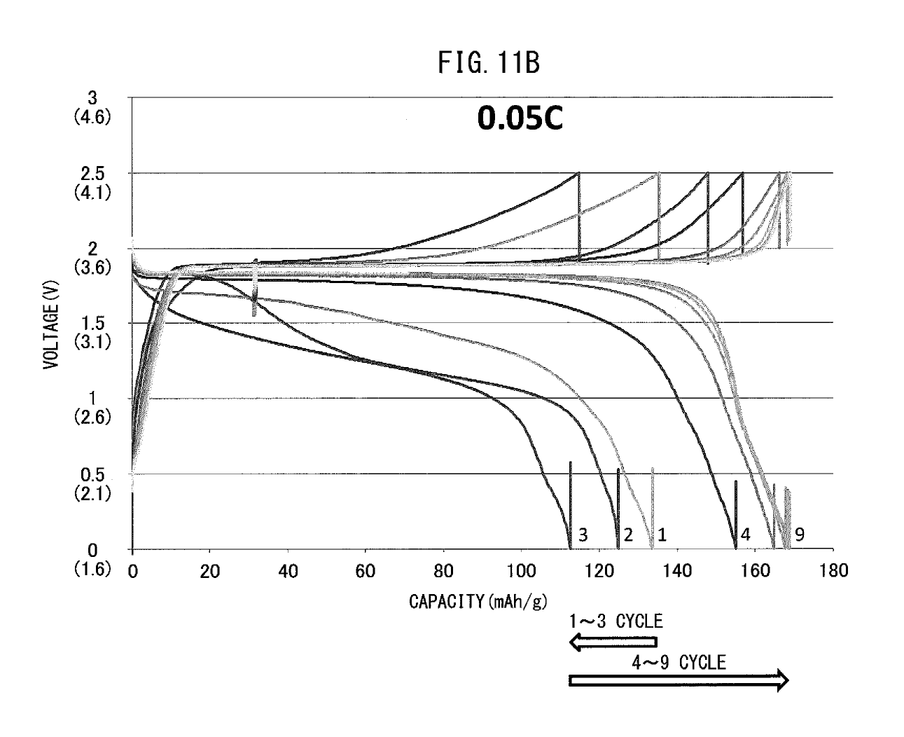

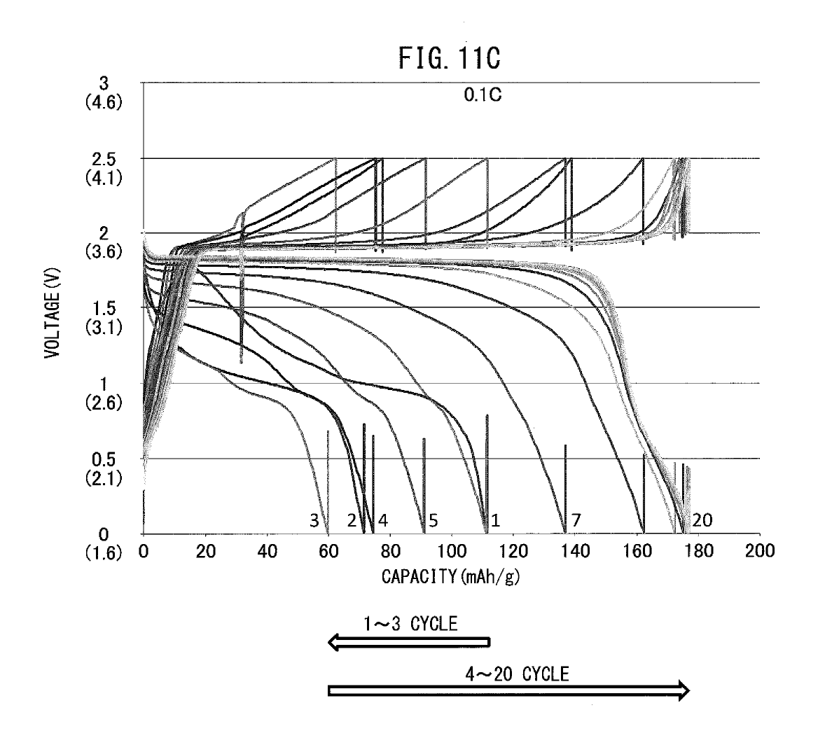

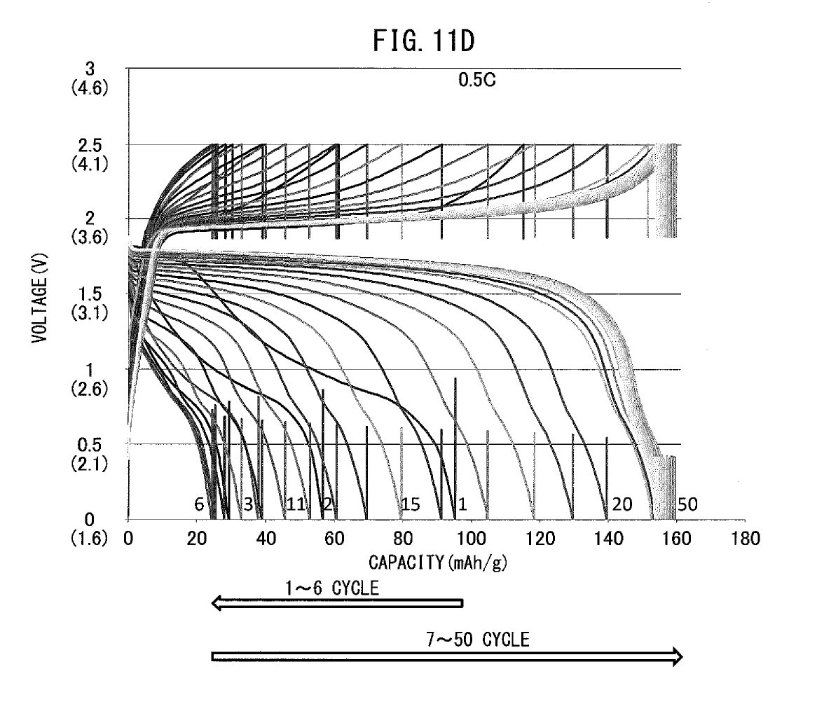

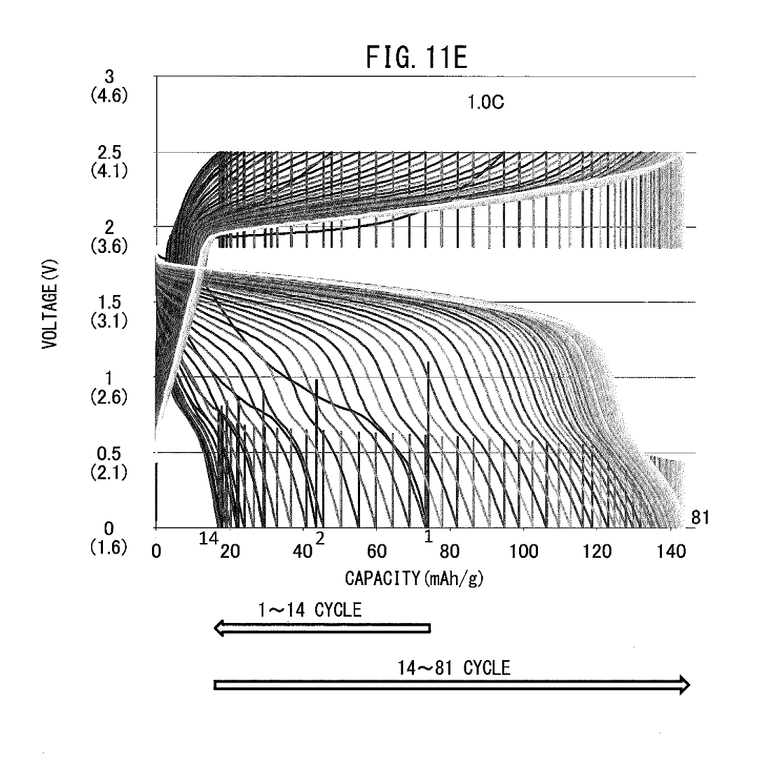

As shown in FIGS. 11B to 11D, in the case of Reference Examples 9 to 11, in which charge-discharge cycles were repeated at 0.05 C, 0.1 C and 0.5 C, potential plateaus appeared at 2.1 V vs. Li/Li⁺ to 2.5 V vs. Li/Li⁺ during the first several cycles of discharging, and as a result of subsequently repeating cycling, potential plateaus in the vicinity of 2.1 V vs. Li/Li⁺ to 2.5 V vs. Li/Li⁺ were no longer observed, and potential plateaus appeared at 3.3 V vs. Li/Li⁺ to 3.5 V vs. Li/Li⁺.

In Reference Examples 9 to 11, this is thought to be due to the resistive layer composed of ion sulfide formed during initial charging having been destroyed by reacting with lithium ions during the first several cycles, followed by the resistive layer being separated from the interface between the positive electrode active material and sulfide solid electrolyte as a result of subsequent charge-discharge cycles, thereby allowing the positive electrode active material to adequately react with lithium ions.

In addition, as shown in FIG. 11E, in the case of Reference Example 12, in which charge-discharge cycles were repeated at a charge-discharge rate of 1.0 C, a potential plateau appeared at 2.1 V vs. Li/Li⁺ to 2.5 V vs. Li/Li⁺ during the first several cycles. However, this potential plateau at 2.1 V vs. Li/Li⁺ to 2.5 V vs. Li/Li⁺ did not disappear even after having repeated charge-discharge cycles numerous times, and battery capacity continued to decrease even after having repeated charge-discharge cycles for 14 cycles. When charge-discharge cycles was further repeated, battery capacity gradually rose, the potential plateau in the vicinity of 2.1 V vs. Li/Li⁺ to 2.5 V vs. Li/Li⁺ was no longer observed, and a potential plateau began to appear at 3.3 V vs. Li/Li⁺ to 3.5 V vs. Li/Li⁺.

Finally, battery capacity stabilized after charge-discharge cycles had been repeated for 81 cycles. This is thought to be due to the short duration of discharge due to the excessively high charge-discharge rate, and since there was therefore little reaction between the resistive layer and lithium ions during a single cycle, the resistance layer was destroyed over the course of a larger number of charge-discharge cycles in comparison with the case of a lower charge-discharge rate.

Conversely, as shown in FIG. 11A, in the case of Reference Example 8, in which charge-discharge cycles were repeated at a charge discharge rate of 0.02 C, a potential plateau appeared in the vicinity of 2.1 V vs. Li/Li⁺ to 2.5 V vs. Li/Li⁺ during initial discharge. Subsequently, however, the potential plateau in the vicinity of 2.1 V vs. Li/Li⁺ to 2.5 V vs. Li/Li⁺ was no longer observed during the second discharge cycle, while a potential plateau appeared at 3.3 V vs. Li/Li⁺ to 3.5 V vs. Li/Li⁺ in the third cycle. This is thought to be due to the long duration of discharge caused by the low charge-discharge rate, resulting in the occurrence of more reactions between the resistive layer and lithium ions during a single cycle.

(4) Temperature (Reference Examples 13 to 17)

The all-solid-state batteries of Reference Examples 14 to 16 were repeatedly subjected to charge-discharge cycles while maintaining the temperature of the batteries at 42° C., 60° C. and 80° C., respectively. As a result, although battery capacity decreased during the first three to four cycles, as a result of subsequently further repeating charge-discharge cycles up to 20 cycles, all-solid-state batteries were able to be obtained that demonstrated high battery capacity.

In particular, battery capacities that approached the theoretical capacity of LiFePO₄ were able to be realized in Reference Example 14 (about 165 mAh/g) and Reference Example 15 (about 175 mAh/g). In addition, final battery capacity in Reference Example 16 was about 110 mAh/g, thereby making it possible to realize high battery capacity, although lower than the theoretical capacity of LiFePO₄.

In the case of Reference Examples 14 and 15, in which charge-discharge cycles were repeated while maintaining the temperatures of the all-solid-state batteries at 42° C. and 60° C., respectively, as shown in FIGS. 10B and 10C, although battery capacity gradually decreased during the first three to four cycles, as a result of subsequently repeating charge-discharge cycles, battery capacity gradually increased, eventually stabilizing at about 165 mAh/g to 175 mAh/g after 20 cycles.

As shown in FIGS. 10B and 10C, in Reference Examples 14 and 15, potential plateaus appeared at 2.1 V vs. Li/Li⁺ to 2.5 V vs. Li/Li⁺ corresponding to the electrical potential of the reaction between iron sulfide and lithium ions during the first three to four discharge cycles. These potential plateaus gradually decreased each time cycling was subsequently repeated, and potential plateaus formed at 3.3 V vs. Li/Li⁺ to 3.5 V vs. Li/Li⁺ corresponding to the reaction potential of LiFePO₄ after 20 cycles.

In Reference Examples 14 and 15, this is thought to be due to the resistive layer composed of iron sulfide formed during initial charging being destroyed by reacting with lithium ions during the first three to four cycles, and as a result of the resistive layer having been separated from the interface between the positive electrode active material and sulfide solid electrolyte due to subsequent charge-discharge cycles, the positive electrode active material was able to adequately react with lithium ions.

In addition, when looking at FIG. 10D, in the case of having repeated charge-discharge cycles while maintaining the temperature of the all-solid-state battery at 80° C. as in Reference Example 16, battery capacity gradually decreased during the first three to four cycles and then subsequently increased and stabilized as a result of repeating charge-discharge cycles in the same manner as in the cases of repeating charge-discharge cycles while maintaining the temperature of the all-solid-state battery at 42° C. or 60° C. However, in the case of a temperature of 80° C., although battery capacity increased as a result of repeating charge-discharge cycles, the final battery capacity was about 110 mAh/g, which was lower than in the case of having carried out charge-discharge cycles at 42° C. or 60° C. This is thought to be due to a reduction in battery capacity attributable to deterioration of the positive electrode active material as charge-discharge cycles were repeated due to the high battery temperature.

In addition, in the case of a temperature of 80° C. as shown in FIG. 10D, the discharge curve was determined to decrease gradually (representing a decrease in capacity) at 2.6 V vs. Li/Li⁺ to 3.4 V vs. Li/Li⁺, and this is presumed to have been caused by the occurrence of side reactions.

On the other hand, in Reference Example 13, in which charge-discharge cycles were repeated while maintaining the temperature of the all-solid-state battery at 25° C., the final battery capacity stabilized at about 140 mAh/g.

In the case of Reference Example 13 as shown in FIG. 10A, a potential plateau at 2.1 V vs. Li/Li⁺ to 2.5 V vs. Li/Li⁺ was hardly observed at all even after repeating charging and discharging, and battery capacity decreased each time charge-discharge cycles were repeated. However, battery capacity gradually began to rise starting at 14 cycles. Battery capacity increased to about 140 mAh/g after 66 cycles.

This is thought to be due to hardly any of the resistive layer formed at the interface between the positive electrode active material and sulfide solid electrolyte during charging of the battery reacting with lithium ions due to the excessively low temperature of the all-solid-state battery, thereby requiring a larger number of charge-discharge cycles until the resistive layer was destroyed.

In Reference Example 17, in which the temperature of the all-solid-state battery was maintained at 100° C., a potential plateau appeared at 2.1 V vs. Li/Li⁺ to 2.5 V vs. Li/Li⁺ during the first several cycles as shown in FIG. 10E. In addition, battery capacity increased to about 200 mAh/g when charge-discharge cycles were repeated for 4 to 6 cycles. However, a potential plateau did not appear at 3.3 V vs. Li/Li⁺ to 3.5 V vs. Li/Li⁺ even if charge-discharge cycles were repeated and battery capacity gradually decreased, eventually decreasing to about 25 mAh/g, which is considerably lower than the theoretical capacity of LiFePO₄.

In this manner, in the case of repeating charge-discharge cycles while maintaining battery temperature at 100° C., the temporary increase in battery voltage indicates that the resistive layer reacts with lithium ions during discharge resulting in a portion of the resistive layer being destroyed. However, since the temperature was excessively high, the positive electrode active material deteriorated and battery capacity was thought to have decreased as charge-discharge cycles were repeated.

In addition, in the case of using a temperature of 100° C. as shown in FIG. 10E, the discharge curve was determined to decrease gradually (representing a decrease in capacity) at 2.6 V vs. Li/Li⁺ to 3.4 V vs. Li/Li⁺, and this is presumed to have been caused by the occurrence of side reactions.

### Reference Example 18

### Assembling and Charging-Discharging of a Battery

An all-solid-state battery was assembled in the same manner as previously described in the section on <Fabrication of All-Solid-State Battery> of the aforementioned section entitled <<Verification of Charge-Discharge Cycle Conditions>>. This all-solid-state battery was charged and discharged for 3 cycles at lower limit discharge potential of 2.1 V vs. Li/Li⁺, upper limit charging potential of 4.1 V vs. Li/Li⁺, charge-discharge rate of 0.1 C and temperature of 60° C. Subsequently, the all-solid-state battery was stored for 40 hours at 80° C. to fabricate an all-solid-state battery.

This all-solid-state battery was then charged and discharged at a lower limit discharge potential of 2.1 V vs. Li/Li⁺, upper limit charging potential of 4.1 V vs. Li/Li⁺, charge-discharge rate of 0.1 C and temperature of 60° C. followed by measurement of battery capacity.

<Results and Discussion>

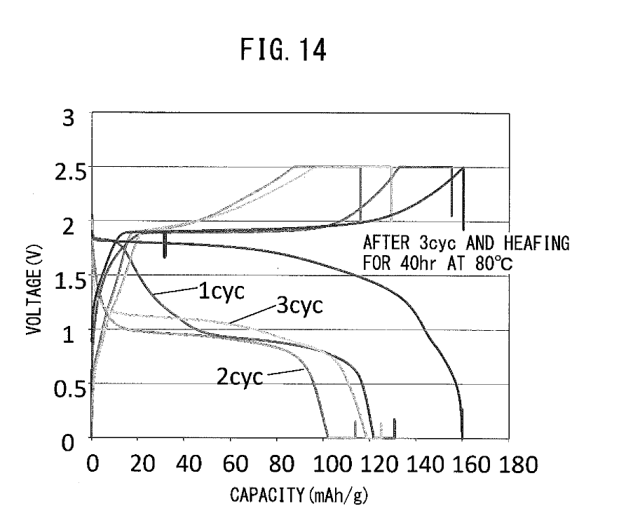

FIG. 14 is a graph representing the relationship between battery voltage, charging capacity and battery capacity for each charge-discharge cycle of this all-solid-state battery.

As shown in the drawing, in Reference Example 18, a potential plateau was present at 2.1 V vs. Li/Li⁺ to 2.5 V vs. Li/Li⁺ through the first three cycles. However, the potential plateau at 2.1 V vs. Li/Li⁺ to 2.5 V vs. Li/Li⁺ was no longer present during charge-discharge cycles after subsequently storing for 40 hours at 80° C., and a potential plateau instead appeared at 3.3 V vs. Li/Li⁺ to 3.5 V vs. Li/Li⁺. In addition, battery capacity also increased to about 160 mAh/g.

In this manner, as a result of storing for 40 hours at 80° C., a potential plateau was no longer observed at 2.1 V vs. Li/Li⁺ to 2.5 V vs. Li/Li⁺, and the reason for the increase in battery voltage is thought to be that the resistive layer, which was destroyed by the first three cycles, was further destroyed as a result of storing for an extended period of time at a high temperature.

### BRIEF DESCRIPTION OF THE REFERENCE SYMBOLS

1 Positive electrode current collector
2a First positive electrode active material layer having first positive electrode active material
2b Second positive electrode active material layer having second positive electrode active material
2c Positive electrode active material layer obtained by uniformly mixing first positive electrode active material and second positive electrode active material
3 Sulfide solid electrolyte layer
4 Negative electrode active material layer
5 Negative electrode current collector
6 All-solid-state battery
7 LiYPO₄
8 LiFePO₄
9 Positive electrode active material particle
10 Primary particle of positive electrode active material
11 Lithium iron phosphate
12 Coating layer
13 Carbon coating layer
14 Resistive layer
15 Transition-metal containing sulfide region

1. An all-solid-state battery having a positive electrode active material layer, a sulfide solid electrolyte layer and a negative electrode active material layer in that order; wherein,
the positive electrode active material layer has a first positive electrode active material represented by LiₓY_{y}PO_{z} wherein, Y represents at least one element selected from the group consisting of Ni, Mn and Co, x is such that 0.5≦x≦1.5, y is such that 0.5≦y≦1.5 and z is such that 2≦z≦7, and a second positive electrode active material represented by Li_{x′}Fe_{y′}PO_{z′} wherein, x′ is such that 0.5≦x′≦1.5, y′ is such that 0.5≦y′≦1.5 and z′ is such that 2≦z′≦7), and
the second positive electrode active material is (1) arranged as the sulfide solid electrolyte layer side part of the positive electrode active material layer, (2) arranged on the surface of particles of the first positive electrode active material, or (3) arranged as the sulfide solid electrolyte layer side part of the positive electrode active material layer and arranged on the surface of particles of the first positive electrode active material.

2. A method for producing an all-solid-state battery having a positive electrode active material layer, a solid electrolyte layer and a negative electrode active material layer in that order; comprising:
producing an all-solid-state battery precursor having the positive electrode active material layer, the solid electrolyte layer and the negative electrode active material layer in that order, and carrying out charge-discharge cycles in which the all-solid-state battery precursor is discharged to 2.1 V vs. Li/Li⁺ or lower while maintaining the temperature of the all-solid-state battery precursor at 25° C. to 80° C.; wherein,
the positive electrode active material layer has a first positive electrode active material represented by LiₓY_{y}PO_{z} wherein, Y represents at least one element selected from the group consisting of Ni, Mn and Co, x is such that 0.5≦x≦1.5, y is such that 0.5≦y≦1.5 and z is such that 2≦z≦7, and a second positive electrode active material represented by Li_{x′}Fe_{y′}PO_{z′} wherein, x′ is such that 0.5≦x′≦1.5, y′ is such that 0.5≦y′≦1.5 and z′ is such that 2≦z′≦7), and
the second positive electrode active material is (1) arranged as the sulfide solid electrolyte layer side part of the positive electrode active material layer, (2) arranged on the surface of particles of the first positive electrode active material, or (3) arranged as the sulfide solid electrolyte layer side part of the positive electrode active material layer and arranged on the surface of particles of the first positive electrode active material.

3. The method for producing an all-solid-state battery according to claim 2, wherein during the charge-discharge cycles, the all-solid-state battery precursor is discharged until the electrical potential of the positive electrode active material layer reaches 1.6 V vs. Li/Li⁺ to 2.1 V vs. Li/Li⁺.

4. The method for producing an all-solid-state battery according to claim 2, wherein the charge-discharge cycles are carried out at a charge-discharge rate of 1.0 C or less.

5. The method for producing an all-solid-state battery according to claim 2, wherein during the charge-discharge cycles, the battery precursor is charged until the electrical potential of the positive electrode active material layer reaches 3.8 V vs. Li/Li⁺ to 4.4 V vs. Li/Li⁺.

6. The method for producing an all-solid-state battery according to claim 2, wherein the charge-discharge cycles are repeated until the discharge capacity of the all-solid-state battery precursor becomes greater than the discharge capacity of the initial charge-discharge cycle of the battery precursor.

7. The method for producing an all-solid-state battery according to claim 2, wherein the charge-discharge cycles are carried out until a discharge plateau is no longer observed at 2.1 V vs. Li/Li⁺ to 2.5 V vs. Li/Li⁺ for the electrical potential of the positive electrode active material layer during discharge.

8. The method for producing an all-solid-state battery according to claim 2, wherein the charge-discharge cycles are carried out until a discharge plateau appears at 3.3 V vs. Li/Li⁺ to 3.5 V vs. Li/Li⁺ for the electrical potential of the positive electrode active material layer during discharge.

9. The method for producing an all-solid-state battery according to claim 2, wherein the plurality of charge-discharge cycles are carried out continuously.

10. The method for producing an all-solid-state battery according to claim 9, wherein the charge-discharge cycles are carried out from the initial charging and discharge.

11. The method for producing an all-solid-state battery according to claim 2, further comprising carrying out the charge-discharge cycles for at least three cycles, followed by warming the all-solid-state battery precursor to 40° C. to 80° C. for 40 hours or more.
